(19) United States
(12) Patent Application Publication
(10) Pub. No.: US 2026/0289252 A1
(43) Pub. Date: Sep. 24, 2026

(54) SYSTEM

(71) Applicant: SoftBank Group Corp., Tokyo (JP)

(72) Inventor: Tsubasa SATO, Tokyo (JP)

(73) Assignee: SoftBank Group Corp., Tokyo (JP)

(21) Appl. No.: 19/558,451

(22) Filed: Mar. 6, 2026

(30) Foreign Application Priority Data
Mar. 19, 2025 (JP) 2025-044519

(51) Int. Cl. G06N 3/0475; G06N 3/0464; G06V 10/56; G06V 10/764; G06V 10/82; G06V 10/94

(52) U.S. Cl. CPC G06N 3/0475; G06N 3/0464; G06V 10/765; G06V 10/82; G06V 10/95; G06V 10/56

(57) ABSTRACT

A system includes a processor that is configured to provide an interface for receiving a product image and optionally entered text, analyze the received product image using an image recognition algorithm to extract a feature of a product shown in the product image, generate a prompt that instructs a generative AI model to select a product description template based on the extracted feature, input the generated prompt to the generative AI model to cause the generative AI model to select the product description template, insert the optionally entered text into the selected product description template to generate a draft product description, and provide the generated draft product description through a user interface.

### CROSS-REFERENCE TO RELATED APPLICATION

This application is based on and claims priority under 35 USC 119 from Japanese Patent Application No. 2025-044519 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for listing products on electronic commerce platforms generally require a user to manually create a product description based on product images and the user's own knowledge. This manual process is time-consuming, requires writing skills, and often results in inconsistent quality and completeness of product descriptions. Furthermore, existing automated tools, when available, tend to provide only simple text suggestions without effectively leveraging image analysis or generative AI models to tailor the description format to the specific product. As a result, many potential sellers face a high barrier to entry, and even experienced sellers expend substantial effort to prepare suitable descriptions, thereby reducing efficiency and potentially lowering the attractiveness of product listings.

### SUMMARY

To solve the above-described problems, a system is provided that comprises a processor configured to provide an interface for receiving a product image and optionally entered text, analyze the received product image using an image recognition algorithm to extract a feature of a product shown in the product image, generate a prompt that instructs a generative AI model to select a product description template based on the extracted feature, input the generated prompt to the generative AI model to cause the generative AI model to select the product description template, insert the optionally entered text into the selected product description template to generate a draft product description, and provide the generated draft product description through a user interface. In some embodiments, the processor is further configured to provide an interface that allows a user to edit the generated draft product description, and to convert the generated draft product description, after editing by the user, into a listing data format in which the product described by the draft product description is listable on an electronic commerce platform.

The term “processor” refers to any hardware component or combination of hardware components, such as a central processing unit (CPU), graphics processing unit (GPU), microcontroller, application-specific integrated circuit (ASIC), field-programmable gate array (FPGA), or a distributed computing system, that executes instructions to perform the functions described in the claims.

The term “interface” refers to any hardware, software, or combination thereof that enables data input from or data output to a user, device, or external system, including but not limited to graphical user interfaces, web pages, application program interfaces (APIs), and communication modules for transmitting and receiving data.

The term “product image” refers to any digital image data, including photographs, illustrations, or rendered images, that visually represents at least a portion of a product to be listed on an electronic commerce platform.

The term “optionally entered text” refers to any textual information that is input by a user on a non-mandatory basis, including but not limited to keywords, phrases, notes, or partial descriptions that the user wishes to have reflected in a product description.

The term “image recognition algorithm” refers to any software, hardware, or combination thereof that analyzes image data to detect, classify, or identify objects, features, or attributes within the image, including but not limited to machine learning models, deep learning models, and rule-based image processing techniques.

The term “feature of a product” refers to any attribute or characteristic of a product that can be inferred from a product image or related data, including but not limited to product category, type, brand, color, size, material, condition, shape, or visual pattern.

The term “prompt” refers to data, including text or structured information, that is provided as input to a generative AI model and that specifies or influences an operation to be performed by the generative AI model, such as selecting a product description template.

The term “generative AI model” refers to any artificial intelligence model configured to generate or select content in response to an input prompt, including but not limited to large language models, text generation models, or other machine learning models capable of producing or selecting natural language output or templates.

The term “product description template” refers to a predefined or dynamically generated text pattern or structure, including placeholders for variable data, that serves as a basis for creating a product description corresponding to a given product type or feature set.

The term “draft product description” refers to a product description text that has been automatically generated, at least in part, by the system based on a selected product description template and optionally entered text, and that is intended to be reviewed and potentially edited by a user before final use.

The term “user interface” refers to any interface, including graphical user interfaces, web pages, mobile application screens, or other interactive displays, through which a user can view, receive, or provide information, including the display and editing of a draft product description.

The term “electronic commerce platform” refers to any online system, website, service, or marketplace that enables users to list, advertise, buy, or sell products or services via electronic communication networks.

The term “listing data format” refers to a data structure or representation, including one or more fields defined by an electronic commerce platform, that specifies information required to create a product listing, such as title, description, price, category, and image references, and that is suitable for submission to the electronic commerce platform.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

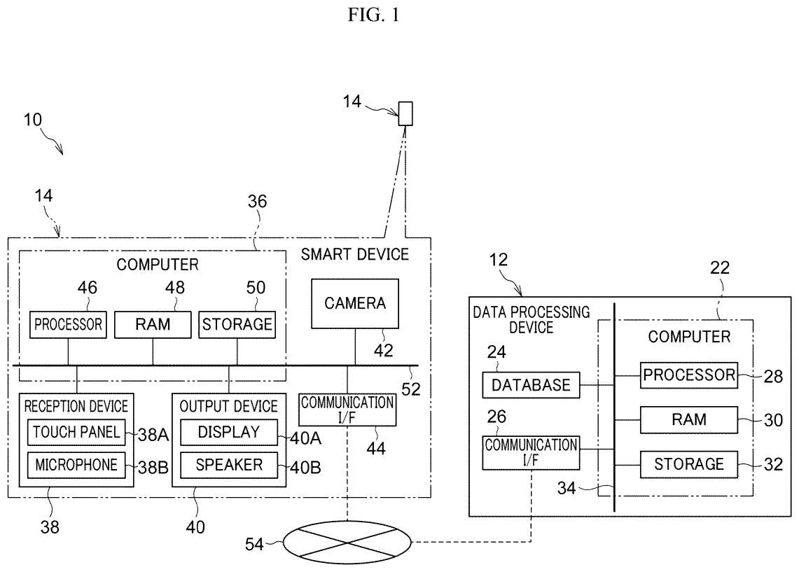

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

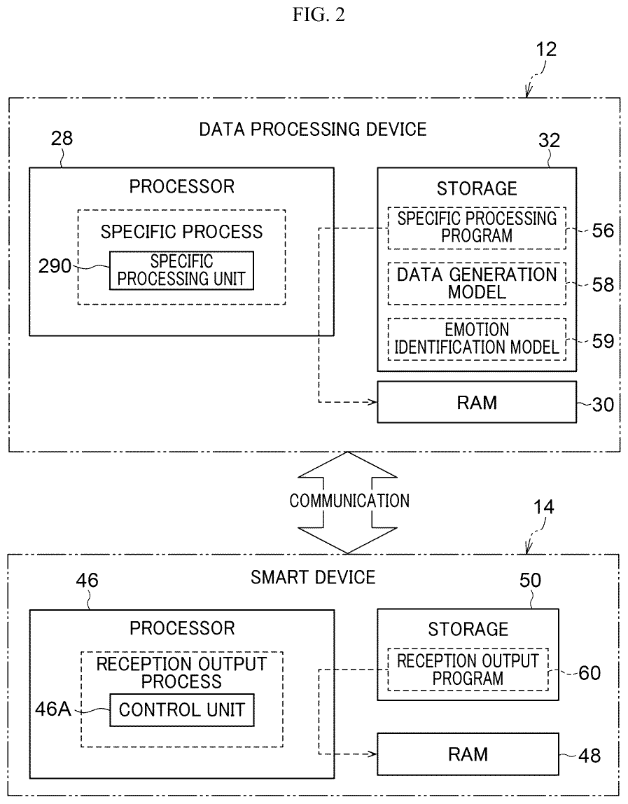

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional e-commerce listing systems rely heavily on manual authoring of product descriptions by sellers. Even when basic template engines or generic text generators are used, the underlying computer processing is typically limited to simple keyword insertion or rule-based formatting that does not fully exploit image-derived product features or user-specified phrases in a structured and coordinated manner. As a result, the processor spends computational resources on repetitive, non-contextual operations, and cannot consistently produce high-quality, product-specific descriptions without substantial human intervention.

Furthermore, many existing systems do not integrate image feature extraction, natural language processing of optional user text, template selection, and generative AI-based refinement into a unified processing pipeline. Image analysis, if used at all, is often decoupled from template selection, and generative AI models are commonly prompted with loosely structured, ad hoc text. This leads to underutilization of machine learning components, inefficient use of memory and network resources when interacting with external AI services, and unpredictable output quality that still requires extensive manual editing by the user. Consequently, the overall computer system does not achieve a technical improvement in how it processes multimodal input data or how it orchestrates multiple algorithms to generate structured, editable product descriptions.

There is thus a need for a computer-based system that improves the way a processor ingests and represents product images and user text, selects and populates description templates based on structured feature information, constructs machine-readable prompt sentences for a generative AI model, and combines template-based text with AI-generated text in a controlled manner. By redesigning the data structures, processing sequence, and interaction with the generative AI model, such a system should reduce redundant computation, stabilize the quality of generated descriptions, and improve the efficiency and reliability of the computer in generating product description drafts that are ready for user editing and final listing on electronic transaction platforms.

The specific processing by the specific processing unit 290 of the data processing device 12 in Example 1 is realized by the following means.

The present invention provides a server comprising a processor configured to provide a user interface to receive, from a user terminal, image information representing a product and optional character information; to apply an image processing algorithm and a machine learning algorithm to pixel information included in the image information to extract structured feature information including category information, color attribute information, shape attribute information, and mark attribute information of the product; to store and retrieve a plurality of description template records in an information storage device and to select, based on the structured feature information, description template information corresponding to at least the product category information and style-related information; to apply a natural language processing algorithm to the optional character information to derive word-level, phrase-level, and semantic-role information, to classify the optional character information into at least product feature information, use-scene information, and advantage information, and to map the classified information to section information or placeholder information of the selected description template information; to generate description text information serving as a draft of a product description by replacing attribute placeholders in the description template information with values derived from the structured feature information and by inserting the classified optional character information into predetermined positions within the description template information; to construct, based on description condition information including the structured feature information and the optional character information, a prompt sentence that programmatically specifies to a generative artificial intelligence model how to generate or improve product description text, to transmit the prompt sentence to the generative artificial intelligence model, and to generate a refined draft of the product description by correcting or extending the description text information using output from the generative artificial intelligence model; and to provide the refined draft of the product description to the user terminal via the user interface in a form that is editable by the user and convertible into listing data for an electronic transaction platform. This enables the server to implement an improved, technically integrated pipeline that efficiently processes multimodal input data, structurally guides a generative AI model via explicit prompt sentences, reduces redundant and manual text authoring operations, and consistently outputs high-quality, structured product description drafts with reduced computational overhead and improved reliability relative to conventional systems.

The term “processor” refers to one or more hardware-based computing units, such as a central processing unit or a graphics processing unit, configured to execute instructions and perform arithmetic, logic, and data management operations.

The term “user terminal” refers to an electronic device operated by a user, such as a personal computer, a smartphone, or a tablet device, that is capable of transmitting and receiving data to and from the server via a communication network.

The term “user interface” refers to a hardware and software combination, such as a graphical user interface displayed on the user terminal, that enables the user to input information, including product image information and character information, and to receive and view output information, including drafts of product descriptions.

The term “image information” refers to digital data representing visual content of a product, including, for example, raster image data encoded in formats such as bitmap, compressed image formats, or any other digital representation of a product image.

The term “pixel information” refers to numerical values or value sets representing color, brightness, or other attributes for individual picture elements that compose the image information.

The term “optional character information” refers to text data provided by the user, including words, phrases, or sentences, that describe desired features, use cases, or selling points of the product, and that may or may not be present for each product.

The term “image processing algorithm” refers to a sequence of computational operations executed by the processor on pixel information, such as resizing, normalization, filtering, feature detection, or other transformation operations used to prepare or analyze the image information.

The term “machine learning algorithm” refers to a computational model or procedure, such as a neural network or a statistical classifier, that has been trained on example data to infer or predict label information or feature information from input data including image information.

The term “feature information” refers to data representing attributes of the product extracted from the image information, including at least category information, color attribute information, shape attribute information, and mark attribute information, and optionally other attributes such as style information.

The term “category information” refers to feature information indicating a generalized product type or class, such as footwear, clothing, or accessory, inferred from the image information.

The term “color attribute information” refers to feature information indicating one or more dominant or representative colors of the product as derived from the pixel information of the image.

The term “shape attribute information” refers to feature information indicating geometric or structural characteristics of the product, such as overall contours, aspect ratio, or form, as inferred from the image information.

The term “mark attribute information” refers to feature information indicating presence, absence, or type of graphic marks on the product, such as logos, symbols, or other brand-related markings, as detected from the image information.

The term “structured data” refers to feature information and related parameters arranged in a machine-readable format, such as key-value pairs or records, that can be processed, queried, or stored by the server in a systematic manner.

The term “information storage device” refers to a memory system, such as a database, a storage medium, or a storage subsystem, configured to store and retrieve data including description template information and related metadata.

The term “description template information” refers to data defining a text pattern or format for a product description, including fixed text segments and placeholder elements that can be replaced by feature information or optional character information.

The term “template record” refers to an individual entry stored in the information storage device, representing one unit of description template information along with associated metadata such as applicable product categories or style attributes.

The term “style-related information” refers to feature information or metadata describing a general stylistic class of the product or description, such as casual, formal, sporty, or other style categories, which is used for selecting suitable description template information.

The term “natural language processing algorithm” refers to a computational procedure that analyzes and processes character information in human language form, including operations such as tokenization, part-of-speech tagging, semantic role labeling, or syntactic parsing.

The term “word-level information” refers to data representing individual tokens or words identified within the optional character information, along with attributes such as part-of-speech tags.

The term “phrase-level information” refers to data representing groups of words forming meaningful units, such as noun phrases or verb phrases, identified within the optional character information.

The term “semantic-role information” refers to data indicating functional roles, such as agent, object, attribute, or purpose, associated with words or phrases within the optional character information.

The term “product feature information” refers to a subset of the optional character information that describes inherent characteristics or properties of the product, such as comfort, weight, or material.

The term “use-scene information” refers to a subset of the optional character information that describes situations, environments, or contexts in which the product is intended or suitable to be used, such as daily use or sports activity.

The term “advantage information” refers to a subset of the optional character information that describes benefits, merits, or positive effects provided by the product, such as improved comfort or enhanced convenience.

The term “section information” refers to data defining logical portions or segments of the description template information, such as an introduction section, feature section, or usage section.

The term “placeholder information” refers to markers or tags embedded within the description template information that indicate positions where variable content, such as feature information or optional character information, is to be inserted.

The term “attribute placeholder” refers to a particular type of placeholder indicating a location in the description template where specific attribute values, such as category information or color attribute information, are to be inserted.

The term “description text information” refers to text data generated by the processor by filling placeholders in the description template information with corresponding feature information and optional character information, and serving as a draft of a product description.

The term “description condition information” refers to data used as a basis for instructing a generative artificial intelligence model, including structured feature information, optional character information, and any additional parameters such as style or length preferences.

The term “prompt sentence” refers to machine-readable text that encodes instructions and contextual information, including description condition information, provided as input to a generative artificial intelligence model to control generation or improvement of product description text.

The term “generative artificial intelligence model” refers to a machine learning model, such as a language model, configured to generate or revise text output based on input text including a prompt sentence.

The term “refined draft of the product description” refers to description text information that has been corrected, expanded, or otherwise modified based on output from the generative artificial intelligence model to improve quality, coherence, or completeness.

The term “listing data” refers to structured data suitable for submission to an electronic transaction platform, including at least product description information, price information, delivery information, and other product-related information.

The term “electronic transaction platform” refers to a network-based system or service that enables offering, searching, purchasing, or selling products via electronic communication, such as an online marketplace or e-commerce system.

In one embodiment, a server executes a program that generates product description drafts by coordinated processing of image information, optional character information, and output from a generative AI model. The server includes at least one processor, a main memory, a non-volatile storage device, and a network interface. The server runs an operating system such as a general-purpose server operating system, and executes application software including a web application framework, an image processing library such as an image processing framework, a machine learning framework such as a tensor-based computation framework, and a natural language processing library such as a general NLP framework. The server stores, in the non-volatile storage device, description template information and associated metadata. The description template information is represented as records in a data storage system, for example in a relational database. Each template record includes fixed text segments, placeholder information, and section information. The server also stores a trained convolutional neural network model for image recognition and a trained language model for text classification or semantic role estimation. The server further maintains configuration data that defines mappings from feature information and optional character information to specific template sections and placeholders.

The terminal is operated by a user and functions as an input and output device for the server. The terminal comprises a processor, a memory, a display unit, an input device such as a touchscreen or keyboard, and a communication module. The terminal executes a client application, which may be a web browser or a dedicated application, and presents graphical user interfaces for uploading product images, entering optional character information, displaying generated product description drafts, and editing the drafts. The terminal communicates with the server via a communication network using a network protocol.

The user operates the terminal to select at least one product image from local storage or from a camera module integrated with the terminal. The user also enters optional character information, such as concise phrases describing comfort, use cases, and advantages. The terminal packages the image information and the optional character information into a request message and transmits the message to the server. The server receives the message via the network interface and stores the image information in temporary storage.

The server uses the image processing library to perform deterministic preprocessing on the image information. The server applies operations such as resizing to a fixed resolution, color space conversion, and normalization of pixel values. These operations ensure that the input to the convolutional neural network has a consistent dimension and distribution, thereby stabilizing inference behavior and improving both processing speed and recognition accuracy.

The server loads the preprocessed image into the convolutional neural network model implemented in the machine learning framework. The model architecture in one embodiment is a residual network having multiple convolutional layers, batch normalization layers, and skip connections. The server executes a forward pass through the network, during which each convolutional layer applies learned filter weights to local pixel neighborhoods and each activation layer applies a non-linear function such as a rectified linear unit. The server obtains, at the output layer, probability distributions over a set of product categories, as well as auxiliary outputs corresponding to colors, shapes, and marks. The server interprets these distributions by selecting, for each attribute type, the labels having probability values above predetermined thresholds.

The server converts the selected labels into structured feature information. For example, the server generates a data structure that associates keys such as “category”, “color”, “shape”, and “mark” with corresponding attribute values. The server may also construct a higher-level style attribute by applying a rule-based mapping from combinations of category, color, and mark labels to style types such as “casual” or “formal”. The server stores this structured feature information in memory, where it is accessible to subsequent modules.

The server accesses the information storage device to retrieve description template information. The server formulates and executes a query that filters template records based on the structured feature information, for example by requiring that the product category and style type of a template record match those of the structured feature information. The server may include ranking logic that gives priority to templates having more specific matching conditions. By narrowing and ranking template records at the database level, the server reduces the volume of data that needs to be loaded into memory and evaluated, thereby improving memory utilization and response time.

The server then uses a natural language processing library to analyze the optional character information. The server cleans the text by normalizing whitespace and punctuation, then tokenizes the text into word-level units. The server applies part-of-speech tagging to each token, and optionally performs dependency parsing to determine syntactic relations. Based on these analyses, the server groups tokens into phrase-level units, such as noun phrases (e.g., “comfortable fit”), prepositional phrases (e.g., “for daily use”), and verb phrases.

The server classifies each phrase into categories such as product feature information, use-scene information, and advantage information. In one embodiment, the server uses a trained shallow neural classifier or a support vector machine that receives as input a feature vector constructed from word embeddings or term-frequency features and outputs a label for each phrase. The server also applies a rule-based post-processing step to ensure that logically inconsistent assignments are corrected, for example by enforcing that phrases including prepositions indicating purpose are preferentially classified as use-scene information.

The server associates each classified phrase with section information and placeholder information within the selected template. For example, the server maps product feature information to a feature section, use-scene information to a usage section, and advantage information to a benefits section. The server maintains a mapping table that defines which placeholders can accept which types of phrases and in what order. This mapping table allows the server to structure the optional character information in a way that reflects the logical layout of a typical product description, producing a more consistent drafting pattern than ad hoc insertion methods.

The server generates description text information by filling the selected template with both structured feature information and the classified optional character information. The server replaces attribute placeholders in the template with concrete attribute values derived from the feature information. The server inserts the classified phrases into the designated placeholders in an order determined by the mapping table or by a scoring function that prefers diverse content coverage. This deterministic template filling process yields a baseline draft that already integrates image-derived attributes with user-provided phrases.

The server further constructs a prompt sentence for a generative AI model. The server encodes the structured feature information, the classified optional character information, and meta-parameters such as desired tone, length, and target platform into a textual instruction. The server arranges this information in a structured and explicit format so that the generative AI model can more reliably capture key constraints and attributes. An example of such a prompt sentence is:
“Product image features: category=sneaker, color=red, style=casual, brand type=sports brand.

User text: ‘comfortable to wear, lightweight, for daily use’.

Based on these details, generate an attractive, concise product description in English for an online marketplace. Emphasize comfort, everyday usability, and casual style. Length: about 120-150 words. Use a friendly and persuasive tone.”

The server transmits the prompt sentence to an external or internal generative AI model via an application programming interface. In one embodiment, the generative AI model is a transformer-based language model with multiple attention layers and feed-forward sub-layers. The model has been trained using a large corpus of text with an objective of predicting next tokens, and optionally fine-tuned using instruction-style prompts and human preference data. The server provides the prompt sentence as input sequence tokens, and the model generates output tokens according to its learned probability distribution, subject to constraints such as maximum length and decoding parameters (for example, temperature and top-k settings).

The server receives the text output from the generative AI model and compares it to the template-based draft. The server may apply evaluation criteria, such as presence of required attributes and absence of disallowed content, by using deterministic string matching or a lightweight classifier. If the output lacks mandatory attributes derived from the structured feature information, the server merges the AI-generated text with segments of the template-based draft to ensure that key information is preserved. This selective merging process differs from simple substitution because it enforces explicit attribute coverage rules that are not typically enforced in manual editing.

The server thus produces a refined draft of the product description that combines the structural stability of the template-based draft with the stylistic richness of the generative AI model. The server returns this refined draft to the terminal via the user interface. The terminal displays the refined draft in an editable region, allowing the user to apply final adjustments. The user reviews and, if necessary, edits the text, then instructs the terminal to submit the finalized description. The server receives the finalized description and converts it into listing data suitable for an electronic transaction platform, including product description, price, shipping details, and other attributes.

This configuration produces technical effects beyond mere automation of human writing. By using fixed-size image preprocessing and a convolutional architecture, the server reduces computational variance and improves hardware utilization, which leads to more predictable processing times and higher throughput. By representing features and user phrases in structured data forms and mapping them to templates and placeholders, the server reduces the search space for description text assembly, which lowers the computational burden on the generative AI model and reduces communication overhead between the server and the AI service, since the prompt sentence can be more concise and focused.

Moreover, by integrating deterministic image-based attribute extraction, structured template filling, and constrained generative refinement, the server enforces internal consistency rules that humans would find difficult to apply at scale. This yields improved accuracy of attribute reflection in the descriptions and reduces error rates such as incorrect category or color mentions. The server also improves data management by storing intermediate representations (feature information, classification labels, and prompt configuration) that can be reused to retrain models or adjust templates, thereby enhancing long-term system adaptability.

In an alternative embodiment, the server employs different neural network architectures. For example, the image recognition component may use a depthwise separable convolutional network to reduce parameter count and inference time. The natural language classification component may use a bidirectional recurrent neural network or a compact transformer encoder to classify phrases into feature, use-scene, and advantage categories. The generative AI model may be hosted locally, with the server controlling decoding details at a lower level, such as limiting vocabulary for certain description segments to reduce hallucination.

In another embodiment, the server uses data augmentation methods, such as random cropping and color jitter, to train or fine-tune the image recognition models, thereby enhancing robustness to varying image conditions. The server may also define a custom loss function during training that penalizes misclassification of certain attributes more heavily than others, such as focusing on accurate product category recognition. During training of the phrase classification model, the server can use a cross-entropy loss and a regularization term, updating model weights using a gradient-based optimization method. These training choices directly influence inference performance and stability in the deployed system.

In still another embodiment, the server optimizes communication with the generative AI model by caching prompt templates and reusing partial prompt segments. The server may compress prompt sentences or batch multiple requests when communicating with an external AI service, thereby reducing network load and latency. The server can also adapt prompt construction based on past generation quality, by adjusting instructions or constraints to achieve better alignment with template structure. This iterative refinement of prompt generation represents a technical optimization in the interaction between the server and the generative AI model, rather than a mere business rule.

By implementing these modules, data structures, and processing flows, the server transforms raw image information and loosely specified user phrases into structured, high-quality product description drafts more quickly and reliably than conventional systems. The combination of structured feature extraction, deterministic template mapping, and controlled generative refinement provides a specific, technically grounded improvement in how a computer system processes multimodal input data and orchestrates multiple algorithms, thereby satisfying the requirements for a concrete technological solution rather than an abstract idea.

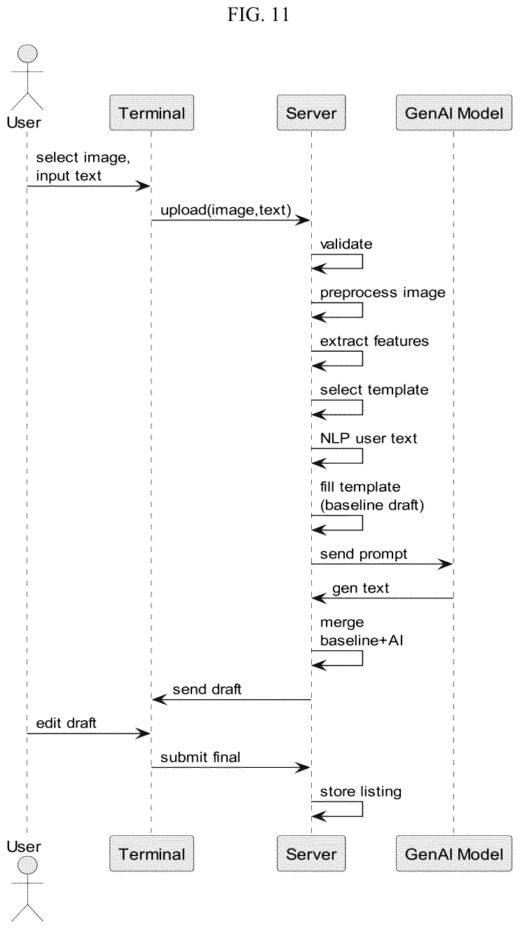

The following describes the processing flow using FIG. 11.

### Step 1:

The user operates the terminal to prepare input data.

The user selects at least one product image stored in the terminal or captured by a camera module and optionally enters character information such as “comfortable to wear, lightweight, for daily use” into an input field on the display.

Input: raw image file(s) (e.g., JPEG, PNG) and optional text strings typed by the user.

Output: a structured request object within the terminal containing image binary data and text data ready for transmission.

### Step 2:

The terminal transmits the request to the server.

The terminal encapsulates the image and text into a network request, for example an HTTP POST message with multipart or JSON data, and sends the request through a communication module over a network to a predefined server endpoint.

Input: the structured request object containing image binary data and optional character information.

Output: a network message delivered to the server that includes the product image information and optional character information.

### Step 3:

The server receives and validates the input data.

The server accepts the network message at an application endpoint, parses the headers and body, and separates the image binary data from the text data. The server checks file type, file size, and character length limits, and rejects malformed or unsupported data.

Input: the network message from the terminal containing raw image data and optional text.

Output: validated image information and validated optional character information stored in server memory, or an error response if validation fails.

### Step 4:

The server preprocesses the image information.

The server loads the binary image into an image processing library, converts it into a pixel matrix, and applies operations such as resizing to a fixed resolution, color space conversion, and normalization. These numerical transformations convert variable-sized, unnormalized images into standardized tensors suitable for input to a convolutional neural network.

Input: validated raw image information.

Output: a normalized image tensor with fixed dimensions and value ranges.

### Step 5:

The server extracts feature information from the image tensor.

The server inputs the normalized image tensor into a trained convolutional neural network running on a machine learning framework, performs a forward propagation through convolution, pooling, and fully connected layers, and computes probability distributions over predefined labels. The server selects the most probable category, color, shape, and mark attributes based on thresholding or argmax operations.

Input: the normalized image tensor.

Output: structured feature information including at least category information, color attribute information, shape attribute information, and mark attribute information.

### Step 6:

The server converts feature information into structured data.

The server maps each recognized label to a key-value representation, aggregates the values into a single feature object, and may derive additional style-related information using rules that combine category, color, and mark attributes.

Input: raw recognition outputs from the neural network (label indices and probabilities).

Output: a structured feature data object containing keys such as “category”, “color”, “shape”, “mark”, and “style”.

### Step 7:

The server selects description template information.

The server uses the structured feature data as query parameters to access a data storage system that holds multiple description template records. The server filters records by matching product category and style and may apply ranking logic to select the template with the highest relevance score.

Input: the structured feature data object and the set of stored template records.

Output: one selected description template record including fixed text segments, section information, and placeholder information.

### Step 8:

The server analyzes the optional character information using natural language processing.

The server tokenizes the text into words, assigns part-of-speech tags, and identifies phrase boundaries with an NLP library. The server then constructs feature vectors for each phrase and applies a classifier or rule set to label each phrase as product feature information, use-scene information, or advantage information.

Input: the validated optional character information string.

Output: a list of classified phrases, each with an associated label indicating feature, use-scene, or advantage.

### Step 9:

The server maps classified phrases to sections and placeholders in the template.

The server consults a mapping configuration that relates phrase categories to template sections and placeholder types. The server assigns each classified phrase to a specific placeholder or section (for example, filling a “feature” slot in a feature section) based on its label and any priority rules.

Input: the classified phrase list and the selected description template record.

Output: a mapping structure that links each placeholder in the template to one or more specific phrases and attribute values.

### Step 10:

The server generates baseline description text information by filling the template.

The server replaces attribute placeholders in the template with concrete values from the structured feature data and inserts the mapped user phrases into the corresponding placeholders. The server concatenates fixed segments and inserted content into coherent sentences, adjusting punctuation and spacing where necessary.

Input: the selected description template record, the structured feature data object, and the mapping structure for user phrases.

Output: baseline description text information serving as an initial draft of the product description.

### Step 11:

The server constructs a prompt sentence for the generative AI model.

The server collects the structured feature data, the classified phrases, and meta-parameters such as desired tone and length, then formats them into a single human-readable instruction string. The server arranges the information in a consistent layout so that the generative AI model can interpret attributes and constraints reliably.

Input: the structured feature data object, the classified phrase list, and configuration parameters for style and length.

Output: a prompt sentence that encodes product attributes, user phrases, and generation instructions for the generative AI model.

### Step 12:

The server obtains refined description text from the generative AI model.

The server sends the prompt sentence to the generative AI model via an API or internal call, receives the generated text output, and decodes it into a character string. The server may configure model parameters such as maximum token length and sampling strategy before sending the request.

Input: the prompt sentence.

Output: AI-generated description text that reflects the prompt conditions.

### Step 13:

The server combines the baseline draft with the AI-generated text.

The server evaluates the AI-generated text for presence of required attributes and compliance with constraints, and if necessary, merges segments of the baseline draft to ensure coverage of critical feature information. The server may, for example, keep an attribute-rich introductory sentence from the template and follow it with stylistically enhanced sentences from the AI output.

Input: the baseline description text information and the AI-generated description text.

Output: a refined draft of the product description that integrates structured attribute coverage with fluent language.

### Step 14:

The server sends the refined draft to the terminal.

The server wraps the refined draft in a response message, optionally including the underlying structured feature data for reference, and transmits the message to the terminal over the network.

Input: the refined draft of the product description.

Output: a response message delivered to the terminal containing the refined draft as a text field.

### Step 15:

The terminal displays the refined draft and accepts user edits.

The terminal parses the response, inserts the refined draft into an editable text area on the display, and allows the user to modify wording or add details using input devices. As the user types, the terminal updates a local text buffer.

Input: the response message from the server and user editing input.

Output: a finalized product description text maintained in the terminal's local state.

### Step 16:

The terminal sends the finalized product description and listing data to the server.

The terminal packages the finalized description together with other listing parameters such as price and shipping options into a follow-up request and sends it to the server for storage and publication.

Input: the finalized product description text and associated listing parameters.

Output: a listing submission message transmitted to the server.

### Step 17:

The server converts the finalized description into listing data for an electronic transaction platform.

The server receives the submission, maps the finalized description and parameters into a platform-specific data structure, and stores them in a database used by the electronic transaction platform. The server may also generate an identifier for the new listing.

Input: the listing submission message from the terminal.

Output: stored listing data including the product description and related attributes, enabling publication and retrieval by the platform.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional product listing workflows in electronic commerce environments rely heavily on manual authoring of product descriptions by sellers. In typical systems, an application server merely stores an image and free-form text provided by a user and presents basic form fields for manual editing. The server does not intelligently interpret the semantic content of a product image, does not systematically structure the user's intent expressed in optional text, and does not coordinate these inputs to drive a generative AI model in a controlled manner. As a result, the quality, consistency, and informativeness of product descriptions depend almost entirely on the user's writing skills and available time. This leads to incomplete or low-quality descriptions, reduced conversion rates, and increased cognitive burden on users.

From a computer-technology perspective, existing systems underutilize the available computing resources and machine learning capabilities. First, the server typically treats product images as opaque files and does not transform image data into structured attribute information that can be programmatically consumed by downstream components. Second, natural language generation, if used at all, is often invoked through simple, unstructured prompts that do not encode machine-derived metadata, template information, or constraints. This causes unstable output quality, difficulty in enforcing business rules (such as mandatory keywords and maximum length), and the need for extensive post-editing. Third, feedback loops from user edits are not captured or reused at the system level: the server usually stores only the final text, without exploiting the edit operations as machine-readable signals for controlling or improving subsequent generations.

Accordingly, there is a need for a computerized technique that technically improves the way a server processes multimodal listing inputs. In particular, there is a need for a server that (i) converts product images into structured attribute data by means of image recognition, (ii) automatically constructs a prompt sentence embedding such attribute data and template control information for a generative AI model, (iii) generates a draft product description under explicit length, keyword, and style constraints, and (iv) feeds user editing operations back into the generative process as additional structured prompts. Such a technique would improve the functioning of the server itself, by transforming raw image and text data into structured representations, by orchestrating generative AI calls in a repeatable and constrained manner, and by reducing the amount of manual editing and network traffic required to obtain acceptable product descriptions.

The specific processing by the specific processing unit 290 of the data processing device 12 in Application Example 1 is realized by the following means.

The present invention provides a server comprising a processor and a communication interface, the processor being configured to acquire, from a user terminal via the communication interface, a product image and optional text data, to preprocess the product image by using a machine-learning-based image recognition algorithm to normalize pixel data and to calculate feature quantities representing the product image, to transform the feature quantities into structured attribute information of a product, to generate a prompt sentence including control information for searching and selecting a product description template associated with a product classification and a style based on the attribute information, to input the prompt sentence into a generative language model to cause the generative language model to generate, in natural language, a product description proposal including information on template selection and insertion positions for the optional text data, to generate a draft product description by combining the selected product description template, the optional text data, and the product description proposal, to apply formatting processes to the draft product description based on predetermined constraints including at least one of a length constraint, a keyword inclusion condition, and a writing style condition, and to transmit the formatted draft product description together with the attribute information as editable display data to the user terminal, and further being configured to acquire, from the user terminal, edit content applied by a user to the draft product description, to reuse updated text data including the edit content as an additional prompt sentence to the generative language model to regenerate or improve the draft product description, and to convert a finalized product description and the attribute information into a listing data format of an electronic commerce platform. This enables the server to technically improve the generation and refinement of product descriptions by transforming raw image and text inputs into structured machine-readable representations, by orchestrating constrained natural language generation under explicit control of templates and attributes, by reducing manual authoring load on the user, and by leveraging user edits as feedback to control subsequent generative operations within the server's data processing pipeline.

The term “processor” refers to a hardware or virtual computing resource, such as a central processing unit or a programmable logic device, configured to execute instructions and perform data processing operations in the system.

The term “user terminal” refers to an information processing apparatus operated by a user, such as a mobile communication device, a tablet device, or a personal computing device, that communicates with the server via a communication network.

The term “communication network” refers to a wired or wireless data transmission infrastructure, including at least one of a local area network and a wide area network, that enables data exchange between the server and the user terminal.

The term “interface” refers to a software-implemented input and output mechanism, such as an application programming interface or a graphical user interface, through which the user terminal and the server exchange data including product images and text data.

The term “product image” refers to digital image data representing visual characteristics of a product, including at least one of color, shape, and surface pattern, acquired by an image capturing device or retrieved from storage.

The term “optional text data” refers to natural language text input by a user in a free-form manner, including at least one of a descriptive sentence, a keyword, and a phrase, which expresses information the user wishes to include in a product description.

The term “image recognition algorithm” refers to a computational procedure that analyzes image data to detect or classify visual features, and that is implemented using at least one of a machine learning model and a deep neural network.

The term “machine-learning-based image recognition algorithm” refers to an image recognition algorithm that utilizes parameters learned from training data to compute feature quantities or classifications from input image data.

The term “pixel data” refers to numerical values associated with individual picture elements of a digital image, including at least one of color values, brightness values, and transparency values.

The term “feature quantity” refers to a numerical representation of a property derived from an input image, such as an embedding vector, a classification score, or a detected attribute value, suitable for use in subsequent data processing.

The term “structured data” refers to data organized in a predefined format, such as a record, a table, or a key-value structure, that allows programmatic access to individual fields representing different attributes of a product.

The term “attribute information” refers to structured data elements that characterize a product, including at least one of a category, a color, a material, a brand indication, a style, and a usage scenario.

The term “storage device” refers to a physical or virtual data storage resource, including at least one of a magnetic storage medium, a semiconductor storage medium, and a network-accessible storage service, used to persistently store data such as product description templates.

The term “product description template” refers to a structured natural language pattern, including predefined sections and placeholders, that defines an arrangement and style for generating a product description.

The term “product classification” refers to a categorization of a product into at least one class, such as a type, a group, or a category, used for selecting an appropriate product description template.

The term “style” refers to a characterization of the tone or presentation form of a product description, including at least one of formal, casual, luxurious, and simple, and is used to select or control a product description template.

The term “prompt sentence” refers to a natural language or structured text expression that is provided as input to a generative AI model to control or guide generation of output text, including at least one of instructions, attribute information, and template selection conditions.

The term “generative AI model” refers to a machine learning model configured to generate output data, such as natural language text, in response to input data including at least one prompt sentence.

The term “generative language model” refers to a generative AI model specialized in producing natural language text, which receives a prompt sentence and outputs a sequence of words or sentences.

The term “product description proposal” refers to natural language text generated by the generative language model, which includes at least information related to a selected product description template and suggested insertion positions for optional text data.

The term “draft product description” refers to an intermediate version of a product description automatically generated by combining at least one product description template, optional text data, and a product description proposal.

The term “formatting process” refers to a procedure that modifies a draft product description to conform to predetermined constraints, including at least one of adjusting the length, inserting required keywords, and harmonizing the writing style.

The term “length constraint” refers to a rule specifying a permissible range of size for a product description, including at least one of a maximum number of characters and a maximum number of sentences.

The term “keyword inclusion condition” refers to a rule requiring that specific terms, such as a product category name or a material name, appear in the generated product description.

The term “writing style condition” refers to a rule constraining the language style of a product description, such as formality level, politeness level, or marketing emphasis, to achieve a consistent tone.

The term “editable display format” refers to a data format and associated presentation configuration that enable a user terminal to display text and allow a user to modify the text through an input operation.

The term “user interface” refers to a set of visual components and input controls presented on a user terminal, such as text fields, buttons, and scrolling areas, through which a user interacts with the system.

The term “edit content” refers to modification operations performed by a user on a draft product description, including at least one of addition, deletion, and replacement of characters, words, or sentences.

The term “updated text data” refers to text data obtained after a user has applied edit content to a draft product description, and which reflects the user's corrections or additions.

The term “additional prompt sentence” refers to a prompt sentence that incorporates updated text data and is supplied to the generative language model after an initial generation process, to control regeneration or refinement of a product description.

The term “regenerate or improve the draft product description” refers to causing the generative language model to perform natural language generation again using an additional prompt sentence so as to produce a new or refined version of the draft product description.

The term “finalized product description” refers to a product description that has been confirmed by a user after editing and that is ready to be used for publication on an electronic commerce platform.

The term “listing data format” refers to a data structure required by an electronic commerce platform to register a product listing, including at least fields for product description, price, category, and image information.

The term “electronic commerce platform” refers to an information processing system that provides functions for publishing, managing, and presenting product listings to potential buyers over a communication network.

The term “listing management function” refers to a function of an electronic commerce platform that stores, updates, and controls information related to product listings, including at least creation, modification, and deletion of listing data.

The term “listing data” refers to a set of information items that define a product offering on an electronic commerce platform, including at least one of a product description, product attributes, pricing information, and associated media.

In one embodiment, a server cooperates with a plurality of user terminals to implement an automatic product description generation system for an electronic commerce platform. The server includes at least one processor, a memory, a non-transitory storage device, and a network interface. The user terminal includes at least one processor, a memory, a display, an input device such as a keyboard or touch panel, an image capturing device such as a digital camera, and a network interface. The server and the user terminal communicate via a wired or wireless communication network using a transport protocol such as HTTPS.

The server executes an application program implemented, for example, using a server-side framework such as a web application framework and a machine learning framework such as a neural network library. The server stores program instructions and data structures, including a set of image recognition models, a set of product description templates, and configuration data for a generative AI model. The user terminal executes a client application, for example, implemented using a cross-platform user interface framework, to present screens for product listing and to transmit user inputs and product images to the server.

The server uses a hardware processing unit such as a central processing unit and, optionally, a graphics processing unit optimized for matrix operations, to perform computationally intensive tasks including image feature extraction and neural network inference. The storage device of the server stores structured data such as product description templates, parameterized rules for length constraints, keyword inclusion conditions, and writing style conditions, as well as logs of generated descriptions and user edits.

The server receives, from the user terminal, digital product image data and optional text data that includes at least one prompt sentence. For example, the user inputs a prompt sentence such as:
“This product is a high-quality red leather handbag. It is stylish and durable.”

The user terminal encodes the product image as a compressed image format and transmits it together with the prompt sentence and associated metadata to the server. The server parses the received request, stores the binary image data in a file system or object storage, and loads the image into an image processing module.

The server applies an image recognition algorithm based on a convolutional neural network architecture. In one embodiment, the server uses a convolutional neural network consisting of multiple convolutional layers, batch normalization layers, non-linear activation functions, pooling layers, and fully connected layers. The server resizes the image to a predetermined resolution, normalizes pixel values, and constructs a multi-dimensional tensor as input to the network. The server executes forward propagation through the network, which computes intermediate feature maps and final feature vectors representing abstract visual properties of the product.

The server maps the final feature vector to human-interpretable attributes using a classification layer and, optionally, additional classifiers trained on labeled product image datasets. The server thereby generates structured attribute information such as category, main color, material, presence or absence of a logo, and style indicators. The server organizes these attributes into a structured data record, for example a key-value structure, stored in memory and indexed by a request identifier.

The server accesses a template database stored in the storage device. The template database contains product description templates designed for various product categories and styles.

Each template includes a set of segments, such as an introductory sentence segment, a material and quality segment, a usage scenario segment, and an optional closing segment.

Each segment may contain placeholders for attributes and for insertion of user-provided text. The server executes a query to retrieve one or more templates that match the recognized category and style. If multiple templates match, the server uses additional criteria, such as length preferences or marketing emphasis, to select a primary template.

The server constructs a prompt sentence for a generative AI model by combining the recognized attribute information, the selected template identifier, and the user's optional text data. The server adds explicit control instructions to the prompt sentence so that the generative AI model generates a product description proposal in a structured manner. For example, the server generates a prompt sentence such as:
“Act as a product copywriter for an online marketplace. The product is classified as a handbag. Attributes: color=red, material=leather, style=elegant. Use the following user-provided sentence and preserve its meaning: ‘This product is a high-quality red leather handbag. It is stylish and durable.’ Follow this structure: (1) short appeal, (2) material and quality, (3) daily use scenarios, (4) closing sentence. Generate a concise and factual product description in English, suitable for an online listing, and do not exceed 120 words.”

The server then provides this prompt sentence as input to a generative language model. In one embodiment, the generative AI model is implemented as a transformer-based neural network trained on large-scale text corpora. The server sends the prompt sentence through a model interface that accepts textual input and returns generated text. The generative language model uses multi-head attention mechanisms, positional encodings, and stacked transformer blocks to compute contextual representations of tokens in the prompt sentence and to sequentially predict output tokens of the product description proposal. The model parameters are obtained by pre-training and optionally fine-tuning with a loss function such as cross-entropy on next-token prediction, and by weight updates using gradient descent-based optimization algorithms.

The server receives the generated product description proposal from the generative language model and parses it as natural language text. The server does not rely solely on the raw output of the model. Instead, the server combines the proposal with the selected product description template and the optional text data according to preset rules. For example, the server inserts the user's prompt sentence or fragments thereof into placeholders in the template, merges segments from the model's proposal into specified positions of the template, and ensures that all mandatory attributes (such as product type, material, and main color) are explicitly present.

The server applies a formatting process to the combined draft product description. The server uses natural language processing operations such as tokenization, part-of-speech tagging, and simple syntactic checks to compute the length of the description in characters or tokens and to detect the presence of required keywords. The server enforces a length constraint by truncating or requesting regeneration if the description exceeds a predetermined threshold.

The server enforces keyword inclusion conditions by confirming that specific terms derived from the attribute information appear in the text. The server enforces writing style conditions by applying rules such as capitalizing the first letter of sentences, ensuring the absence of prohibited phrases, and approximating a desired tone. By performing these operations algorithmically on structured text and attribute data, the server optimizes the description for the constraints of the electronic commerce platform.

The server transmits the formatted draft product description and the associated attribute information to the user terminal in a data format that the client application can render as an editable text area with additional metadata display. The user terminal displays the draft product description and, optionally, a list of recognized attributes. The user can review the content, identify errors, and edit specific phrases or sentences using the input device. The user terminal records any inserted, deleted, or replaced text segments as edit content.

The server acquires the edit content and the updated text data from the user terminal. The server analyzes the differences between the original draft and the edited version to extract patterns of user preference or corrections. The server constructs an additional prompt sentence that embeds the edited text and explicit instructions that the generative language model should adjust future descriptions consistently. For example, the server may construct an additional prompt sentence such as:
“Improve the following product description by incorporating the user's edits and maintaining factual accuracy. Original draft: [original text]. User-edited version: [edited text]. Preserve the user's added details about an inner zip pocket and adjustable shoulder strap, and keep the length within 120 words.”

The server uses this additional prompt sentence to request a regenerated or refined product description from the generative language model. The server then performs the same formatting and constraint enforcement process on the regenerated description, thereby obtaining a new draft that better reflects the user's intent while adhering to system-level constraints. Because the server stores the edit operations and uses them to construct structured prompts, the system improves over time in terms of alignment with user expectations and reduction in manual editing requirements.

The server converts the finalized product description, after the user confirms the content, together with the attribute information and other listing parameters, into a listing data format required by the electronic commerce platform. The server populates fields such as product title, long description, bullet points, and searchable keywords using parts of the generated description and the attribute information. The server writes the listing data into a database associated with the electronic commerce platform or transmits it through an application programming interface to the platform's listing management function.

The server improves computer technology in several ways. First, the server transforms raw multimodal input (image pixels and free text) into structured attribute information using a dedicated image recognition pipeline and structured data representations. This transformation enables efficient indexing, retrieval, and rule-based validation that are not possible when product images are treated as opaque data. Second, the server constructs prompt sentences that embed machine-derived attributes, template identifiers, and constraint specifications. This structured prompt construction yields more stable and controllable outputs from the generative language model, reduces variance in output length and content, and decreases the number of regeneration cycles, thereby lowering computational load and network traffic.

Third, the server performs a post-generation formatting process that algorithmically enforces constraints and ensures inclusion of critical attributes, thereby reducing the need for repeated manual editing and further calls to the generative language model. By filtering and correcting outputs before transmission to the user terminal, the server reduces communication overhead and improves response time perceived by the user. Fourth, the server collects and reuses edit content as a form of feedback signal. By representing edits as structured differences and embedding them in additional prompt sentences, the server effectively implements a closed-loop control of the generative process that adapts to user behavior, improving accuracy and reducing errors in subsequent descriptions.

The server uses non-conventional processing sequences and rules that differ from human manual writing. For example, the server decomposes the description into segments linked to attribute fields, enforces token-level constraints based on attribute-derived keywords, and merges template segments with model-generated segments using algorithmic criteria rather than simple concatenation. The server operates according to predetermined rules for mapping attributes to text placeholders, for ranking candidate templates, and for rejecting outputs that violate length or content constraints. These rules and data structures, including attribute vectors, template metadata, and prompt construction patterns, are specific to the computational environment and are not merely an automation of a human mental process.

The server can be implemented in alternative embodiments. In one alternative, the server uses a different neural network architecture for image recognition, such as a residual network or a vision transformer, but still converts the output to structured attribute information in the same manner. In another alternative, the server stores templates in a structured document store instead of a relational database but maintains key fields such as category, style, and segment definitions. In yet another alternative, the server uses a locally hosted generative language model instead of a remote service, but still constructs and provides prompt sentences and enforces the same constraints.

The terminal can also vary in implementation. In one variation, the user terminal is a mobile communication device with an integrated camera and touch screen, while in another variation, the user terminal is a desktop computing device using a separate image capturing device and a pointing device. In either case, the terminal operates according to the same logical roles: capturing and transmitting product images, receiving and editing draft product descriptions, and confirming finalized descriptions.

By coordinating the server-side pipelines for image recognition, structured attribute extraction, template selection, prompt sentence construction, constrained text generation, and feedback-based refinement, the system achieves improved processing speed, reduced error rates in product attribute mention, and more efficient data management. The technical configuration of the server and the specific processing of data within the machine lead to concrete improvements in the operation of the computer system itself, rather than solely automating a human business task.

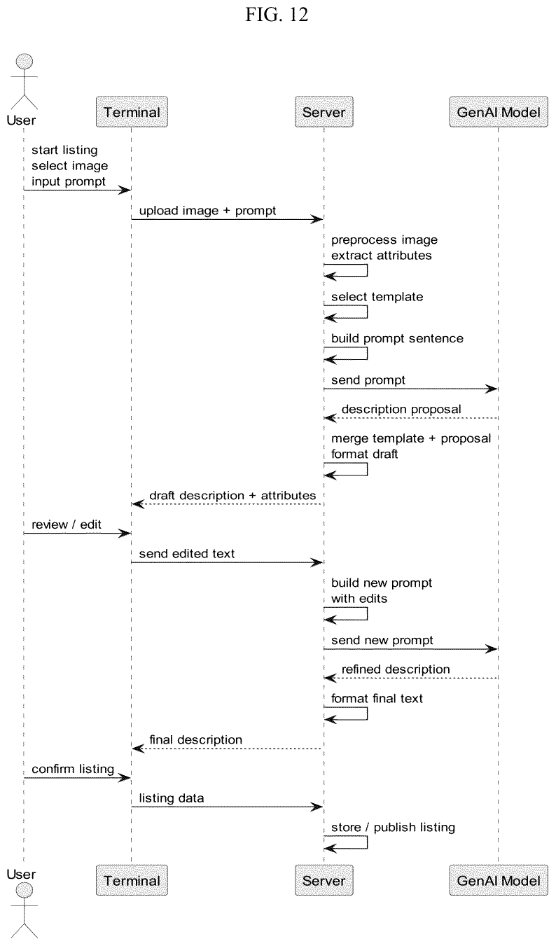

The following describes the processing flow using FIG. 12.

### Step 1:

User operates the terminal to start a new product listing.

User uses the terminal camera or file selection interface to capture or select at least one product image and to input at least one prompt sentence as optional text data.

Terminal receives the raw image data (for example, a JPEG file) and the prompt sentence as character data, associates them with a temporary listing identifier in local memory, and displays a preview of the selected image and text.

Terminal prepares a request payload that includes the image data (binary), the prompt sentence (string), and additional metadata (for example, desired language, category hint), and sets the payload in a structure for transmission to the server.

### Step 2:

Terminal transmits the request payload to the server via a communication network.

Terminal opens an HTTPS connection to an endpoint on the server, attaches the image binary and prompt sentence as multipart or equivalent structured data, and sends the request.

Server receives the request via a network interface, parses the incoming data stream to separate the image binary, prompt sentence, and metadata, and stores each component in a request-scoped data structure in memory.

Server writes the image binary to a temporary storage location and assigns a file path or identifier that will be used as input to an image processing module.

### Step 3:

Server executes an image preprocessing and feature extraction operation.

Server loads the stored image from the temporary path, decodes the compressed image into a pixel matrix, and resizes and normalizes the pixel values according to the input specification of a convolutional neural network.

Server inputs the normalized pixel tensor into an image recognition model, performs forward propagation through convolutional layers, pooling layers, and fully connected layers, and calculates one or more feature vectors that numerically represent the visual characteristics of the product.

Server applies classification heads or attribute prediction layers to the feature vectors and outputs structured attribute information, such as product category, color, material, and style, encoded in a structured record.

### Step 4:

Server selects an appropriate product description template based on the attribute information.

Server uses the structured attribute information (for example, category=handbag, style=elegant) as input to a template selection routine that queries a template database stored in the storage device.

Server executes a search operation using the attribute values as keys, retrieves one or more candidate templates, and evaluates their suitability according to rules such as match score or preferred length.

Server outputs a selected template identifier and associated template structure, including segment definitions and placeholders for attributes and user text.

### Step 5:

Server constructs a prompt sentence for a generative AI model.

Server uses, as input, the attribute information, the selected template structure, and the user's original prompt sentence.

Server assembles these inputs into a single textual prompt by concatenating instructions, attribute descriptions, template section descriptions, and the user's sentence, and by inserting control phrases that indicate length limits, tone, and required content.

Server outputs a complete prompt sentence string that encodes both the content and control information needed by the generative AI model.

### Step 6:

Server invokes the generative AI model with the constructed prompt sentence.

Server sends the prompt sentence to a generative language model interface and sets model parameters such as maximum token count and randomness control.

Generative AI model receives the prompt sentence as a sequence of tokens, processes the tokens through internal transformer layers that compute context-aware embeddings, and incrementally predicts output tokens using its learned weight parameters.

Server receives the generated token sequence from the generative AI model, decodes the tokens into natural language text, and outputs a product description proposal that follows the requested structure and content.

### Step 7:

Server generates a draft product description by combining multiple data sources.

Server uses, as input, the selected template, the user's original prompt sentence, the structured attribute information, and the product description proposal obtained from the generative AI model.

Server inserts attribute values and user text into placeholders in the template, aligns segments of the model-generated proposal with the corresponding template segments, and merges overlapping or redundant sentences according to predetermined rules.

Server outputs a composite draft product description text that reflects both machine-derived attributes and user-provided information.

### Step 8:

Server applies formatting and constraint enforcement to the draft product description.

Server analyzes the draft text using a natural language processing module to compute its length, to detect the presence of required keywords derived from attributes, and to check for disallowed phrases.

Server compares the measured length to a stored length constraint and, if necessary, truncates or slightly reformats sentences while maintaining grammatical correctness.

Server inserts missing mandatory keywords or flags violations for regeneration, and adjusts sentence capitalization and punctuation to conform to a predefined writing style.

Server outputs a formatted draft product description that satisfies the length, keyword, and style constraints.

### Step 9:

Server transmits the formatted draft product description to the terminal for user review.

Server packages the formatted draft text and the associated attribute information into a response structure and sends it to the terminal over the communication network.

Terminal receives the response, parses the data structure, and stores the draft description and attributes in local memory associated with the current listing.

Terminal displays the draft product description in an editable text field and, optionally, shows the recognized attributes in a separate area of the user interface.

### Step 10:

User reviews and edits the draft product description on the terminal.

User reads the displayed draft, compares it with the actual product, and uses the input device to insert, delete, or modify text segments.

Terminal records the original draft text and the edited text, and computes the differences as edit content, for example by identifying added sentences such as “Includes an inner zip pocket and adjustable shoulder strap.”

Terminal outputs the edited text and, optionally, the edit content differences as structured data for transmission to the server.

### Step 11:

Server receives edits and optionally regenerates or refines the description using the generative AI model.

Server accepts the edited text and edit content from the terminal and stores them in memory linked to the original draft.

Server analyzes the differences between the original and edited texts to determine which information the user added or changed, and encodes these changes into a new prompt sentence that instructs the generative AI model to preserve the edits and improve cohesion or style.

Server sends this additional prompt sentence to the generative AI model, receives a regenerated product description that incorporates the user's corrections, and applies the same formatting and constraint checks as in the previous steps, thereby outputting an improved draft description.

### Step 12:

User confirms a finalized product description and submits listing data.

User views the improved or edited draft on the terminal and, when satisfied, performs an input operation such as pressing a confirmation button.

Terminal uses the confirmed text as the finalized product description, packages it with product images, attribute information, and other listing fields into a listing data structure, and transmits this structure to the server or to an electronic commerce platform interface.

Server receives the finalized description and associated data, converts them into a platform-specific listing data format, and outputs listing data ready for registration in the platform's listing management system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for generating product descriptions for electronic commerce platforms typically rely on static templates or simple keyword-based text generation that is manually configured by developers. In such systems, an application program often selects a fixed template based solely on a manually assigned category code, and inserts user-entered text fragments into predetermined slots. This architecture suffers from several technical problems.

First, the processing pipeline does not exploit the rich visual information contained in image data of a transaction target article. The server generally treats image data and text data as separate, loosely coupled inputs, so that product descriptions cannot be automatically adapted to fine-grained attributes, such as subtle appearance features, logo patterns, or configuration details discernible from the image. As a result, the processor fails to generate contextually appropriate descriptions without extensive manual intervention, leading to inefficient utilization of compute resources and storage structures used to maintain large numbers of templates.

Second, conventional systems do not integrate visual feature extraction with generative AI models through a structured prompt sentence construction mechanism. Typically, generative language models are invoked with simple prompts that contain only user-entered text or a minimal category label. In such architectures, the server does not systematically transform machine-readable feature vectors obtained from machine learning models into natural language context for the generative model. This causes suboptimal use of the generative AI model's internal representation capacity, often producing generic or inaccurate descriptions and requiring repeated user corrections. The need for manual post-editing increases network traffic, server load, and user interaction latency.

Third, existing systems usually lack a coordinated post-processing pipeline to enforce platform-specific constraints on the generated descriptions. The server may accept raw text from a generative model without robust, automated checks for prohibited expressions, excessive length, or inconsistent formatting relative to listing data schemas. As a result, the system may generate product descriptions that do not comply with marketplace policies or data formats, forcing additional manual review or downstream transformation. This leads to complex and fragmented application code, inefficient memory usage, and increased error handling overhead across distributed components.

Fourth, the interaction between the description generation pipeline and the listing record management in conventional systems is frequently decoupled. Generated text is often copied or pasted manually into listing forms, and the server does not maintain a consistent association between visual features, intermediate prompts, candidate sentences, and finalized listing records. This prevents the system from optimizing caching, re-use of inference results, and reliable conversion into standardized listing data formats. Consequently, the overall computer system exhibits increased response times, redundant computation, and inefficient database operations.

Accordingly, there is a need for an improved computer-implemented technique in which a processor: (i) converts raw product image data into structured feature information by using a trained inference model; (ii) constructs a prompt sentence in natural language that encodes both extracted feature information and user-provided text as context for a generative AI model; (iii) obtains, from the generative AI model, a product description candidate sentence that conforms to a selected template; and (iv) performs automated post-processing and structured storage of the candidate sentence so that it can be directly integrated into listing data records. Such a technique should improve the technical functioning of the overall system by reducing redundant user edits, ensuring format compliance at the server side, and efficiently coupling visual inference, prompt generation, and text generation in a unified processing pipeline.

The specific processing by the specific processing unit 290 of the data processing device 12 in Example 2 is realized by the following means.

The present invention provides a server comprising a processor configured to receive, via at least one display device and at least one input device connected to an information processing apparatus, image data of a transaction target article and arbitrary character information related to the transaction target article from a user; preprocess the image data by using an image processing program and a machine learning program executed on the information processing apparatus, and convert the image data into numerical sequence data suitable for inference processing by the machine learning program; execute, on the numerical sequence data, a trained inference model including at least one of a classification processing model, a feature extraction model, and an object detection model, and extract feature information including attribute information, appearance information, and identification information of the transaction target article; apply a template selection rule to the feature information to select, from among a plurality of description template data stored in a storage device, description template data corresponding to at least one of a type and a category of the transaction target article, and specify the description template data; construct, as a prompt sentence described in a natural language, context information including the feature information and the arbitrary character information, designation information related to the description template data, and instruction information related to at least one of a style, a length, and an expression range of a description sentence; input the prompt sentence to a generative AI model including a generative language model that executes natural language generation processing, and obtain, from the generative AI model, a product description candidate sentence that conforms to a format of the description template data; execute post-processing on the product description candidate sentence, the post-processing including at least one of detection of prohibited expressions, length adjustment, format adjustment, and conversion into structured data; and store the post-processed product description candidate sentence in association with the arbitrary character information, and cause the post-processed product description candidate sentence to be displayed, in an editable state, on the display device via a user interface, and further configured to acquire edit content applied to the product description candidate sentence, generate a finalized product description sentence reflecting the edit content, convert the finalized product description sentence into a listing data format for electronic commerce, generate a listing data record including the finalized product description sentence, the image data, and transaction condition information related to the transaction target article, and convert the listing data record into a transmission data format transmittable to an electronic commerce service via a communication network. This enables an integrated computer-based pipeline in which visual feature extraction, prompt sentence construction, generative AI text generation, and listing data structuring are cooperatively executed by the processor, thereby improving system-level performance by reducing manual editing operations, ensuring automatic compliance with format and policy constraints, optimizing utilization of machine learning resources, and decreasing processing latency for generating and publishing product descriptions in an electronic commerce environment.

The term “processor” refers to a hardware computation unit or a combination of hardware computation units, including at least one central processing unit, microprocessor, or processing core, which is configured to execute machine-readable instructions to perform the functions described in the claims.

The term “information processing apparatus” refers to an electronic device or a combination of electronic devices, such as a server device, a client device, or a terminal device, that includes at least one processor, at least one memory, and at least one communication interface, and that is capable of executing application programs and performing data processing.

The term “display device” refers to an output device, such as a liquid crystal display, an organic light emitting display, or another visual display unit, that is configured to present graphical or textual information to a user in association with the information processing apparatus.

The term “input device” refers to an input unit, such as a keyboard, a pointing device, a touch panel, a microphone, or another user input interface, that is configured to receive operation signals or input information from a user.

The term “transaction target article” refers to any physical or digital item, including goods, products, or services, that is intended to be listed, offered, or traded on an electronic commerce platform.

The term “image data” refers to digital data representing a still or moving image, including at least one frame encoded in a format such as a bitmap format or a compressed format, which depicts a transaction target article.

The term “arbitrary character information” refers to text information freely provided by a user, including at least one word, phrase, or sentence, that the user desires to incorporate into or have reflected in a product description.

The term “image processing program” refers to a software component or set of instructions executable by a processor to perform operations on image data, such as decoding, resizing, normalization, cropping, or other preprocessing operations.

The term “machine learning program” refers to a software component or set of instructions executable by a processor to implement a machine learning algorithm, including at least an inference function that processes input data to generate output data based on a trained model.

The term “numerical sequence data” refers to data represented as one or more numerical arrays, tensors, or vectors, which are suitable as input to a machine learning program for inference processing.

The term “trained inference model” refers to a model obtained by training on training data using a machine learning algorithm, the model being configured to receive input data and output inference results such as classifications, feature representations, or detections without further training during normal operation.

The term “classification processing model” refers to a trained inference model that outputs, in response to input data, at least one class label or probability value associated with one or more predefined classes.

The term “feature extraction model” refers to a trained inference model that outputs, in response to input data, a feature representation such as a feature vector, embedding, or descriptor expressing characteristics of the input data.

The term “object detection model” refers to a trained inference model that outputs, in response to input data, at least one object-related prediction including at least one of a bounding region, a class label, and a confidence score for an object present in the input data.

The term “feature information” refers to information derived from inference results of a trained inference model, including at least one of attribute information, appearance information, and identification information of a transaction target article.

The term “attribute information” refers to data expressing properties of a transaction target article, such as category, type, size, material, function, or specification.

The term “appearance information” refers to data expressing visual characteristics of a transaction target article, such as color, shape, pattern, design, or external configuration.

The term “identification information” refers to data expressing an identifier associated with a transaction target article, such as a brand indication, a logo indication, a model indication, or another identifying mark.

The term “storage device” refers to a physical or logical storage medium, such as a semiconductor memory, a magnetic storage medium, an optical storage medium, or a distributed storage system, configured to store data persistently or semi-persistently.

The term “description template data” refers to data representing a template or skeleton of a product description, including at least one fixed phrase and at least one placeholder or slot for insertion of variable information such as features or user-provided text.

The term “template selection rule” refers to logic, conditions, or criteria, implemented by executable instructions or configuration data, for selecting particular description template data based on at least one element of feature information.

The term “context information” refers to information that provides semantic or situational background for generating a sentence, including at least one of feature information, arbitrary character information, and metadata related to a transaction target article.

The term “designation information” refers to information that specifies or identifies particular description template data, a product type, a category, or other elements to be used by a generative AI model when generating a sentence.

The term “instruction information” refers to information that defines constraints or guidelines for generated text, including at least one of style, length, tone, format, or expression range.

The term “prompt sentence” refers to a sequence of natural language text that encodes at least context information, designation information, and instruction information, and that is provided as an input to a generative AI model.

The term “generative AI model” refers to a machine learning model configured to generate text, including at least a generative language model that receives a prompt sentence and outputs one or more candidate sentences or sequences of tokens.

The term “generative language model” refers to a machine-learned model, such as a neural network based model, that performs natural language generation by predicting sequences of words, tokens, or characters in response to input context.

The term “product description candidate sentence” refers to a sentence or a sequence of sentences output by a generative AI model in response to a prompt sentence, expressing a candidate description of a transaction target article.

The term “post-processing” refers to processing applied to a product description candidate sentence after generation, including at least one of detecting prohibited expressions, adjusting length, adjusting format, or converting the sentence into structured data.

The term “prohibited expressions” refers to words, phrases, or patterns of text that are disallowed by a predetermined rule, policy, legal requirement, or platform guideline.

The term “format adjustment” refers to processing that modifies a layout or structure of text, including at least one of adding or removing line breaks, punctuation, markup tags, or list structures.

The term “structured data” refers to data organized according to a predetermined schema, such as a key-value structure, a table structure, or a markup structure, that enables systematic storage, retrieval, and processing.

The term “user interface” refers to a software-based interaction layer, including graphical components displayed on a display device and input handling routines processed by a processor, which allows a user to view and edit information.

The term “edit content” refers to modification information applied by a user to a product description candidate sentence, including at least one of inserted text, deleted text, or replaced text.

The term “finalized product description sentence” refers to a product description sentence obtained after applying edit content provided by a user to a product description candidate sentence.

The term “listing data format” refers to a data representation conforming to a specification defined for storing or transmitting listing information on an electronic commerce platform.

The term “listing data record” refers to a data structure that includes at least a finalized product description sentence, image data, and transaction condition information, and that is suitable for use as a listing on an electronic commerce service.

The term “transaction condition information” refers to information related to conditions of trading a transaction target article, including at least one of price, quantity, shipping conditions, payment conditions, and availability status.

The term “transmission data format” refers to a data representation conforming to a communication protocol or an interface specification, which allows a listing data record to be transmitted over a communication network.

The term “communication network” refers to a wired or wireless communication infrastructure, including at least one of a local area network, a wide area network, or a public network, through which data is exchangeable between the server and an external service.

In one embodiment, a server cooperates with at least one terminal operated by a user to implement the claimed system. The server includes at least one processor, at least one main memory, at least one non-volatile storage device, and at least one network interface.

The terminal includes an information processing apparatus, such as a smartphone, tablet, or personal computer, having a display device, an input device, and a communication interface. The server and the terminal communicate with each other via a communication network.

The terminal displays, on the display device, a graphical user interface implemented by client-side software such as a web browser or a native application. The terminal provides an image selection control and one or more text input controls. The user operates the terminal to capture or select image data of a transaction target article, for example, a product to be listed on an electronic commerce platform. The user also operates the terminal to input arbitrary character information, such as keywords, phrases, or short sentences, that the user desires to emphasize in a product description.

The terminal transmits, through the communication interface, the selected image data and the arbitrary character information to the server by using a communication protocol such as HTTP over TLS. The server receives the image data and the arbitrary character information and stores them temporarily in the storage device and the main memory. The server then invokes an image processing program, which may be implemented using a software library such as an image manipulation library, and a machine learning program implemented in a machine learning framework such as a neural network framework.

The server decodes the image data into a multidimensional numerical array representing pixel values. The server normalizes the pixel values and resizes the array to a predefined resolution, for example 224 by 224 pixels with three color channels, to generate numerical sequence data suitable for input to a trained inference model. The server structures the numerical sequence data in a tensor format used by the machine learning framework so that the numerical sequence data can be efficiently processed on a vectorized computation unit, such as a graphics processing unit or a specialized accelerator.

The server loads, from the storage device into the main memory, a trained inference model that has been previously trained on image data of various categories of articles. In one example, the trained inference model has a neural network architecture including convolutional layers, batch normalization layers, non-linear activation layers, pooling layers, and fully connected layers, similar to a residual network architecture. The server configures the machine learning program to execute the trained inference model in an inference mode without updating weights.

The server inputs the numerical sequence data into the trained inference model and executes a forward propagation operation. The server causes the processor or an attached accelerator to compute convolution operations, matrix multiplications, and activation functions to generate internal feature maps and, finally, an output feature vector and class-related scores. The server converts the output feature vector and the scores into feature information including attribute information, appearance information, and identification information. For example, the server can map a highest-scoring class index to a category label such as “portable communication device,” and can derive appearance information such as “black color,” “rectangular flat shape,” and “bezel-less display” from intermediate feature maps or from an auxiliary object detection branch.

The server structures the feature information as a data object having fields for a category identifier, one or more attribute identifiers, and one or more appearance descriptors. The server stores the feature information in association with the original image data. The server then applies a template selection rule to the feature information. The server accesses, from the storage device, a plurality of description template data records, each record having a template identifier, a category condition, and a template body containing fixed sentences and placeholders. The server evaluates the category condition for each description template data record against the category identifier in the feature information and selects at least one description template data record that satisfies the condition.

The server identifies, for the selected description template data record, placeholder positions representing values such as product type, brand, color, and key features. The server does not directly insert the feature information and the arbitrary character information into the template body. Instead, the server constructs a prompt sentence for a generative AI model. The server converts the feature information into a natural language description, for example, “product type=smartphone, brand=generic brand, color=black, design=bezel-less large display.” The server also retrieves the arbitrary character information provided by the user, such as “latest model” and “high-resolution camera.”

The server aggregates the natural language feature description, the arbitrary character information, a reference to the selected template, and instruction information regarding style and length into a single prompt sentence. In one specific example, the server constructs the following prompt sentence: “The system has analyzed a product image and extracted the following features: product type=smartphone, brand=Brand X, color=black, design=bezel-less large display. The seller has provided the following keywords: ‘latest model’, ‘high-resolution camera’. Using a friendly and persuasive tone suitable for an online auction site, write a concise English product description that clearly highlights the product type, brand, color, design, and the given keywords. Limit the description to about 3 sentences.”

The server provides this prompt sentence as input to a generative AI model. In one embodiment, the generative AI model is a generative language model having a transformer architecture including a plurality of attention layers, feedforward layers, and positional encoding mechanisms. The generative AI model has been trained in advance on large-scale text corpora using supervised learning and self-supervised learning techniques, with an objective function such as a cross-entropy loss between predicted token sequences and ground truth sequences. The generative AI model is further fine-tuned on domain-specific product description data to improve its ability to generate commercially suitable descriptions.

The server encodes the prompt sentence into token sequences based on a vocabulary. The server transmits the token sequences to the generative AI model, which may execute on the same server hardware or on a separate inference server. The generative AI model computes, for each token position, probability distributions over the vocabulary using multi-head self-attention operations and feedforward transformations. The server obtains, from the generative AI model, a sequence of tokens representing a product description candidate sentence. The server decodes the sequence of tokens into natural language text.

The server then executes post-processing on the product description candidate sentence. The server applies a rules-based filter and, optionally, a lightweight classifier to detect prohibited expressions or patterns that do not comply with predefined guidelines. The server trims the product description candidate sentence to a predefined maximum length and adjusts formatting, for example by inserting line breaks or punctuation as required by a data schema.

The server then converts the product description candidate sentence into structured data, for example by splitting the text into paragraphs, titles, and bullet points for storage in separate fields of a database record.

The server stores the post-processed product description candidate sentence in association with the arbitrary character information, the feature information, and the image data in a storage device. The server transmits a representation of the post-processed product description candidate sentence to the terminal. The terminal displays the sentence on the display device in an editable state within a user interface. The user can review the text and apply edits via the input device.

The server acquires edit content from the terminal. The server generates a finalized product description sentence by integrating the edit content with the product description candidate sentence. The server converts the finalized product description sentence into a listing data format that complies with an electronic commerce platform's schema, including data fields for title, description body, and metadata. The server generates a listing data record including the finalized product description sentence, the image data, and transaction condition information such as price and shipping terms. The server converts the listing data record into a transmission data format compatible with a network interface and transmits the record to an electronic commerce service.

In one embodiment, the server uses a modular software architecture. The server includes an image preprocessing module, a feature extraction module, a template management module, a prompt construction module, a generative AI interaction module, a post-processing module, and a listing management module. Each module operates on defined data structures. For example, the feature extraction module outputs a feature object having fields “category_id,” “appearance_vector,” and “brand_confidence,” while the prompt construction module accepts such object and outputs a prompt sentence string. This modularization enables the server to reuse intermediate results and minimizes redundant computation.

The server improves computer technology by tightly coupling the image-based inference pipeline with the generative AI pipeline through prompt sentence construction. The server does not merely automate a human authoring task; instead, the server introduces a non-conventional data flow in which intermediate numerical feature vectors are systematically converted into natural language context, thereby causing the generative language model to operate under more precise constraints. This combination reduces the need for repeated generation and manual corrections, which in turn reduces processing time and network usage.

The server improves processing speed by avoiding exhaustive template search and by using feature-based indexing of templates. The template selection rule maps feature information to template identifiers using precomputed associations. This reduces database access costs and allows the server to use caching for frequently used categories. The server further improves computational efficiency by executing the trained inference model and the generative AI model on specialized hardware accelerators and by batching multiple requests when possible.

The server improves accuracy of product descriptions by using image-derived feature information rather than relying solely on user-entered text. The trained inference model extracts subtle visual features, such as design details and logo placement, that are not easily captured by users. The server incorporates these features into the prompt sentence, which causes the generative AI model to generate descriptions that more accurately reflect the actual appearance and properties of the transaction target article. This reduces discrepancies between displayed content and actual items, thereby decreasing user complaints and returns.

The server improves data management by converting generated descriptions into structured data compatible with listing data formats. The post-processing module ensures that the generated content is normalized, checked against prohibited expressions, and formatted in accordance with predefined schemas. This allows the electronic commerce system to efficiently index, search, and filter listings, leading to improved performance of retrieval queries and recommendation algorithms.

The server trains the trained inference model and the generative language model in a manner that further enhances technical performance. For the trained inference model, the server, in a training phase, uses labeled image datasets and optimizes the model parameters by gradient-based methods, such as stochastic gradient descent or adaptive moment estimation, using loss functions including classification loss and, when applicable, localization loss for object detection. The server performs data augmentation, such as random cropping, rotation, and color jittering, to increase robustness to variations in captured product images.

The server fine-tunes the generative language model on product description corpora. The server uses a sequence-to-sequence training objective in which the input sequence includes structured feature information converted to text and the target sequence includes human-written descriptions. The server computes a token-level loss, such as cross-entropy loss, and updates model weights by backpropagation. This training improves the model's ability to map feature markers and keywords to coherent, domain-specific sentences, which in turn improves the quality and relevance of the generated product description candidate sentences during inference.

The server applies rules and non-standard processing orders that differ from conventional manual description workflows. For example, the server may first generate a coarse-grained description from image-derived features and then refine it using user-entered keywords by a second prompt sentence, rather than simply appending keywords to existing text. The server may also encode constraints, such as “avoid promotional claims exceeding certain thresholds,” as explicit text conditions in the prompt sentence, which are not commonly used in manual authoring. These rules and processing orders are optimized for interaction with the generative AI model and for compliance with electronic commerce standards.

The terminal benefits from reduced computational and interaction load. The terminal delegates heavy computation, such as running neural network models and performing post-processing checks, to the server. The terminal only needs to perform lightweight rendering operations and transmit user inputs. This architecture enables terminals with limited resources, such as mobile devices, to participate in the system while relying on the server's more powerful processing capabilities.

In another embodiment, the server may deploy different trained inference models or generative language models depending on product category or regional language. The server can select a model variant optimized for fashion items, another for electronics, and another for household goods. The server may also select generative language models specialized for different languages or writing styles. In yet another embodiment, the server may incorporate an additional feedback loop in which user edit content is logged and later used as training data to refine the generative language model, thereby gradually improving generation accuracy and reducing future editing needs.

In all these embodiments, the server integrates feature extraction, prompt sentence construction, generative AI text generation, and listing data structuring in a coordinated manner. This integration provides technical effects that include but are not limited to reduced processing latency, improved text accuracy, reduced network traffic due to fewer regeneration cycles, improved database consistency, and enhanced utilization of specialized computing resources.

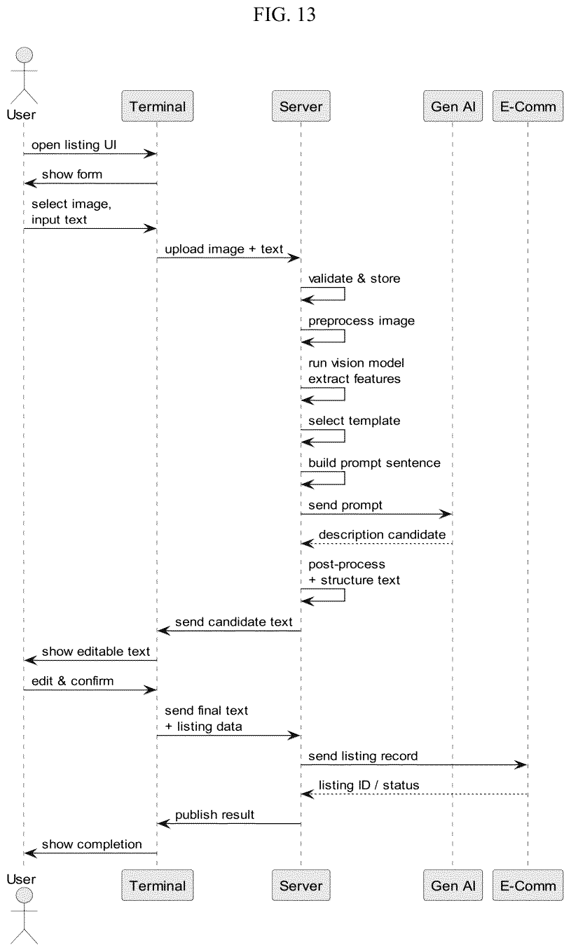

The following describes the processing flow using FIG. 13.

### Step 1:

The terminal displays, on a display device, a listing creation screen that includes an image selection control and a text input field. The user operates the terminal to select or capture product image data from local storage or a camera module and to input arbitrary character information such as keywords or short phrases. The terminal packages the selected image data and the arbitrary character information into a request message, for example using a multipart/form-data structure, and transmits the message to the server via a communication interface over a communication network.

Input: User operations (image selection and text input).

Output: A network request containing image data and arbitrary character information.

### Step 2:

The server receives, through a network interface, the request containing the image data and the arbitrary character information. The server parses the request to separate the binary image data from the text fields and stores the image data in a storage device while holding the arbitrary character information in main memory. The server validates file type and size of the image data by inspecting header bytes and metadata to confirm conformance to supported formats.

Input: Network request containing image data and arbitrary character information.

Output: Validated image file stored in a storage device and arbitrary character information stored in main memory.

### Step 3:

The server invokes an image processing program to decode the stored image file into a multidimensional pixel array. The server then resizes the pixel array to a fixed resolution (for example, 224 by 224 pixels) and normalizes pixel values to a predetermined range (for example, scaling to [0,1] and subtracting mean values). The server converts the normalized pixel array into numerical sequence data formatted as a tensor that conforms to a machine learning framework's expected input layout. The data processing includes linear scaling and matrix reshaping operations that map raw pixel indices into a consistent tensor shape.

Input: Validated image file.

Output: Normalized numerical sequence data in tensor format.

### Step 4:

The server loads a trained inference model into main memory, the model being implemented in a machine learning framework and having a neural network architecture with convolutional, normalization, activation, pooling, and fully connected layers. The server inputs the numerical sequence data tensor into the trained inference model and executes forward propagation using vectorized numerical operations on a processor or attached accelerator. The server obtains raw inference outputs such as class scores, intermediate feature vectors, and, when applicable, bounding box coordinates.

Input: Numerical sequence data in tensor format.

Output: Raw inference outputs including class scores and feature vectors.

### Step 5:

The server performs post-processing on the raw inference outputs to extract structured feature information. The server applies a softmax function to the class scores to compute probability values and selects a category identifier corresponding to the highest probability. The server interprets elements of the feature vector and, optionally, detection outputs to derive appearance information such as color and shape, and identification information such as a brand indication. The server aggregates these values into a feature object containing fields for category, attribute information, appearance information, and identification information.

Input: Raw inference outputs (class scores, feature vectors, detection results).

Output: Feature object containing structured feature information.

### Step 6:

The server accesses a template repository stored in the storage device, which contains multiple description template data records associated with different categories or types of articles. The server applies a template selection rule that compares the category field and other elements in the feature object with conditions stored in the template repository, for example by matching category identifiers or attribute flags. The server selects a description template data record whose conditions are satisfied by the feature object.

Input: Feature object containing category and attribute information.

Output: Selected description template data record.

### Step 7:

The server retrieves the template body and placeholder definitions from the selected description template data record. The server converts the feature object into a natural language text fragment, for example, “product type=smartphone, brand=Brand X, color=black, design=bezel-less large display.” The server retrieves the arbitrary character information from main memory and designates it as keywords or phrases to be emphasized. The server also prepares instruction information describing tone, length, and constraints. The server concatenates these components into a single natural language prompt sentence.

Input: Selected description template data record, feature object, arbitrary character information, and instruction parameters.

Output: Prompt sentence in natural language that encodes context information, designation information, and instruction information.

### Step 8:

The server encodes the prompt sentence into tokens using a tokenizer associated with a generative AI model. The server submits the token sequence to the generative AI model, which may execute on the same server or a connected inference server, and specifies generation parameters such as maximum token length and sampling strategy. The generative AI model processes the tokens through multiple attention layers and feedforward layers to compute probability distributions over the vocabulary at each step, and the server samples or selects tokens according to the specified strategy. The server collects the generated tokens as a sequence representing a product description candidate sentence.

Input: Prompt sentence in natural language.

Output: Token sequence representing a product description candidate sentence.

### Step 9:

The server decodes the token sequence into a text string forming the product description candidate sentence. The server executes post-processing operations, including scanning the text with pattern-matching rules or a lightweight classifier to detect prohibited expressions, truncating the text if it exceeds a predetermined length, and inserting formatting elements such as line breaks and separators according to a listing schema. The server optionally splits the text into logical segments such as title and body and converts these into a structured data format such as key-value pairs.

Input: Token sequence representing a product description candidate sentence.

Output: Post-processed product description candidate sentence in both free-text and structured data formats.

### Step 10:

The server stores the post-processed product description candidate sentence, together with the feature object, the image data reference, and the arbitrary character information, in a database record. The server generates a response message containing the product description candidate sentence and transmits the response to the terminal via the communication network. The terminal receives the response and renders the product description candidate sentence within an editable text field on the display device.

Input: Post-processed product description candidate sentence and associated metadata.

Output: Database record stored on the server and an update message sent to the terminal, resulting in display of the editable candidate sentence.

### Step 11:

The user reviews the displayed product description candidate sentence on the terminal and operates the input device to edit the text if necessary. The terminal records the edit content by calculating differences between the original candidate sentence and the edited version or by capturing the final edited text directly. The terminal packages the edit content and the context identifier of the listing into a request and transmits it to the server.

Input: Displayed product description candidate sentence and user edit operations.

Output: Network request containing edit content or finalized text.

### Step 12:

The server receives the edit content or finalized text from the terminal and merges the edit content with the stored product description candidate sentence to generate a finalized product description sentence. The server converts the finalized product description sentence into a listing data format by mapping text segments to schema fields defined by the electronic commerce platform. The server updates or creates a listing data record including the finalized product description sentence, the image data reference, and transaction condition information such as price and shipping options. The server converts the listing data record into a transmission data format compatible with an external electronic commerce service.

Input: Edit content or finalized text and stored candidate sentence and metadata.

Output: Finalized product description sentence and listing data record in a transmission-ready format.

### Step 13:

The server transmits the listing data record in the transmission data format to the electronic commerce service over the communication network, using a protocol such as an application programming interface defined by the service. The server receives an acknowledgment or response from the electronic commerce service, including, for example, a listing identifier or status code, and stores this in association with the listing data record. The terminal receives a notification from the server and displays a confirmation message indicating that the listing, including the generated and finalized product description, has been successfully published.

Input: Listing data record in transmission data format.

Output: Listing registration on an electronic commerce service and confirmation information displayed on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems for generating product descriptions using automatic text generation typically rely only on static product attributes and manually entered keywords. In many cases, such systems merely map detected visual attributes of a product image directly into a fixed template, or pass simple attribute labels as input to a generative model. As a result, these systems suffer from several technical limitations in terms of information processing performance and output quality.

First, conventional systems do not effectively integrate heterogeneous input signals, such as image information, user-input text, and emotion-related signals, into a single, machine-interpretable representation suitable for controlling a generative AI model. In particular, prior approaches generally fail to perform unified feature extraction and fusion across visual attributes, natural language keywords, and user emotion states. This leads to inefficient use of available input data and produces product descriptions that either omit key information or repeat trivial attributes, thereby degrading the effective information density and utility of the generated text.

Second, known systems lack a structured mechanism for constructing prompt sentences for a generative AI model based on combined attribute information, phrase information, and emotion information. Without such a mechanism, the generative model often receives underspecified or noisy prompts that do not accurately encode the underlying product context and user intent. This increases computational waste because repeated calls or manual corrections are required to obtain acceptable output. It also limits the controllability of the generative process, which in turn reduces consistency, predictability, and robustness of the system under varying input conditions.

Third, conventional systems do not provide a feedback-driven post-processing loop that programmatically enforces inclusion of important user phrases and compliance with predefined constraints on description length and style. Existing approaches typically rely on humans to verify whether required keywords appear in the generated text and whether the output conforms to platform-specific style guidelines. This manual verification not only increases latency and processor load on user devices, but also prevents automatic optimization of the generative model's usage. Consequently, system-level performance, including throughput, resource utilization, and user-perceived responsiveness, is negatively impacted.

Fourth, the lack of automated correction and regeneration logic tied to explicit criteria (for example, keyword coverage and stylistic constraints) results in repeated, ad-hoc interactions with the generative AI model. Each additional interaction requires establishing a new request, transferring data, and executing model inference, thereby consuming network bandwidth and computational resources unnecessarily. This behavior is particularly problematic in large-scale environments where many users concurrently request description generation.

Accordingly, there is a need for an improved computer-implemented system that (i) systematically extracts attribute information, phrase information, and emotion information from heterogeneous inputs, (ii) constructs a well-formed prompt sentence that encodes these fused features for a generative AI model, and (iii) automatically verifies and corrects the generated draft product description based on explicit, programmable criteria. Such a system should reduce redundant generative calls, improve the quality and consistency of the generated descriptions, and enhance overall processing efficiency of the information processing apparatus and associated network services.

The specific processing by the specific processing unit 290 of the data processing device 12 in Application Example 2 is realized by the following means.

The present invention provides a server comprising a processor configured to receive, from a user terminal, image information representing a product and character information representing user-input text related to the product, to analyze the image information by inputting the image information to an image processing program and extracting attribute information of the product from the image information, to analyze the character information by inputting the character information to a natural language processing program and extracting phrase information related to the product from the character information, to estimate an emotional state of a user by inputting at least one of facial information, voice information, and input operation information acquired from the user terminal into an emotion estimation program and to generate emotion information based on the estimated emotional state, to generate, on the basis of the attribute information, the phrase information, and the emotion information, a description request sentence including contents of the product image, phrases input by the user, and the emotional state of the user and to generate a prompt sentence for input to a generative information generation model by using the description request sentence as the prompt sentence for the generative information generation model, to input the prompt sentence to the generative information generation model, to cause the generative information generation model to generate candidate information for a product description sentence, and to obtain a product description template or a product description sentence from the candidate information, to generate a draft product description by inserting or reflecting, in the obtained product description template or the obtained product description sentence, expressions corresponding to the phrase information and the emotion information, to determine whether each phrase included in the phrase information is contained at least once in the draft product description and, when a phrase that is not contained in the draft product description exists, to automatically add wording including the phrase to the draft product description to correct the draft product description, and to compare a length and a writing style of the draft product description with predetermined criteria and, when the length or the writing style deviates from the predetermined criteria, to generate an additional prompt sentence instructing the generative information generation model to perform summarization or style conversion of the draft product description, to input the additional prompt sentence to the generative information generation model, and to regenerate or modify the draft product description based on an output result from the generative information generation model. This enables the server to computationally integrate heterogeneous input signals into a unified prompt sentence for controlled interaction with the generative information generation model, to automatically enforce keyword coverage and stylistic constraints on the generated draft product description, to reduce redundant generative processing and manual corrections, and thereby to improve overall efficiency, consistency, and responsiveness of computer-implemented product description generation.

The term “system” refers to a combination of hardware and software components including at least one processor and associated memories, interfaces, and programs configured to execute the claimed processing.

The term “processor” refers to a hardware computing element, such as a central processing unit or other arithmetic and logic execution unit, capable of executing instructions of a program to perform data processing operations.

The term “user terminal” refers to an electronic apparatus operated by a user, such as a portable information device, a stationary information device, or another communication-capable device, that can capture, input, display, and transmit information to and from a server.

The term “image information” refers to digital data representing visual content of a product, including pixel data encoded in one or more image formats or video formats, which can be processed by an image processing program.

The term “character information” refers to digital data representing text entered by a user, including letters, numbers, symbols, or strings in a specified character encoding, which can be processed by a natural language processing program.

The term “product” refers to any item, good, or article that is the subject of a listing or transaction in an information processing environment, including tangible objects and intangible items represented by associated data.

The term “image processing program” refers to software instructions executable by a processor, configured to analyze digital image information to detect, classify, or quantify visual characteristics.

The term “attribute information” refers to structured data representing characteristics of a product derived from image information, including classifications, labels, or numerical values corresponding to properties such as category, color, shape, material, or style.

The term “natural language processing program” refers to software instructions executable by a processor, configured to analyze character information in a human language and to extract linguistic features, tokens, or semantic information.

The term “phrase information” refers to structured data representing terms, phrases, or keywords derived from character information and indicating user-specified concepts, attributes, or emphasis related to a product.

The term “facial information” refers to digital data representing an image or sequence of images of a user's face, suitable for analyzing facial expressions or movements used for estimating an emotional state.

The term “voice information” refers to digital audio data representing sound generated by a user, including speech segments, suitable for analyzing prosodic or acoustic features used for estimating an emotional state.

The term “input operation information” refers to data indicating temporal or behavioral characteristics of a user's input actions, including keystroke timings, pointing operations, or interaction patterns, which can be used to infer an emotional state.

The term “emotion estimation program” refers to software instructions executable by a processor, configured to analyze at least one of facial information, voice information, and input operation information and to output emotion information indicating an estimated emotional state of a user.

The term “emotion information” refers to structured data representing an estimated emotional state of a user, including labels, confidence values, or multidimensional scores indicating valence, arousal, or other emotional dimensions.

The term “description request sentence” refers to a natural language text constructed by the processor that encodes attribute information, phrase information, and emotion information into a coherent request for generation of a product description.

The term “prompt sentence” refers to a natural language text, including at least the description request sentence, provided as an input condition to a generative information generation model to control the content, style, or structure of generated text.

The term “generative information generation model” refers to a trained computational model, such as a neural network-based generative model, configured to receive a prompt sentence and to output candidate information including natural language text based on learned patterns.

The term “candidate information for a product description sentence” refers to one or more generated text outputs produced by the generative information generation model in response to a prompt sentence, the outputs being suitable for use as a product description or for derivation of a product description.

The term “product description template” refers to a text structure, pattern, or format suitable for describing a product, including predefined or partially generated sentences with placeholders, into which other information can be inserted.

The term “product description sentence” refers to a natural language text that describes a product, generated or selected by the processor from candidate information output by the generative information generation model.

The term “draft product description” refers to a product description text generated by the processor based on a product description template or product description sentence, in which phrase information and emotion information are inserted or reflected, and which is intended to be a preliminary version subject to review or further modification.

The term “user interface” refers to a functional arrangement of input and output components, including display elements and input controls, that allows a user to view, confirm, or modify information, including a draft product description, on a user terminal.

The term “phrase not contained in the draft product description” refers to a phrase included in the phrase information whose textual representation or equivalent expression does not appear within the content of the draft product description as determined by the processor.

The term “wording including the phrase” refers to one or more textual segments generated or selected by the processor that contain a phrase from the phrase information or an equivalent expression of that phrase.

The term “length of the draft product description” refers to a quantitative measure of the size of a draft product description, expressed in units such as characters, words, tokens, or sentences.

The term “writing style of the draft product description” refers to a set of textual characteristics of a draft product description, including tone, formality, grammatical construction, and structural organization.

The term “predetermined criteria” refers to one or more conditions or thresholds, defined in advance in configuration data or program logic, specifying acceptable ranges or types for the length and writing style of the draft product description.

The term “additional prompt sentence” refers to a prompt sentence generated by the processor after initial generation of a draft product description, the additional prompt sentence including instructions for summarizing or transforming the style of the existing draft product description.

In one embodiment, a server cooperates with one or more terminals operated by users to generate a draft product description using a generative AI model controlled by a structured prompt sentence. The server includes at least one processor, a main memory storing executable programs and model parameters, a nonvolatile storage device storing training data and configuration data, and a communication interface for exchanging data with the terminals over a network. The terminal includes at least one processor, a camera, a microphone, an input device, a display, and a communication interface.

The terminal executes an application program stored in a local memory. The terminal application provides a graphical user interface through which a user captures a product image, inputs text, and optionally allows acquisition of emotion-related signals. The terminal controls the camera hardware to acquire still images or short video of a product and the user's face, controls the microphone to acquire audio signals corresponding to the user's voice, and controls an input device such as a touch panel or keyboard to accept character input and to record input timing information. The terminal converts raw sensor outputs into digital data in predetermined formats, for example, encoding images as compressed raster data and encoding audio as digital waveforms with a fixed sampling rate. The terminal generates request data structures including the product image data, the character data representing keywords, and, when permitted, facial image data, voice data, and input operation data, and transmits the request data structures to the server via a communication protocol such as HTTP over a secure transport.

The server executes an image processing program implemented using an image processing library and a trained convolutional neural network (CNN). The server stores CNN parameters representing multiple convolutional layers, pooling layers, and fully connected layers in the main memory. The server defines intermediate feature tensors for each layer as data structures indexed by spatial position and channel index. The server feeds a normalized image tensor, derived from the received product image data, into the CNN and performs convolution operations, nonlinear activation, and pooling operations on a graphics processor or on a general purpose processor with vectorized instructions. The server outputs attribute information such as product category, estimated color class, shape class, material class, and style class as structured attribute vectors. In a variation, the server uses an off-the-shelf image classification model and attaches an additional fully connected layer that is trained to output attributes specific to product description, such as “formal”, “casual”, “vintage”, or “modern”.

The server executes a natural language processing program implemented using a tokenization module, an embedding module, and a neural encoder such as a transformer-based sequence model. The server transforms the character information received from the terminal into a sequence of tokens using a vocabulary. The server applies an embedding matrix to map each token into a dense vector representation. The server passes the vector sequence through multiple layers of self-attention and feedforward transformations. The server obtains phrase information represented as a set of keyword vectors and associated semantic tags. The server applies a classification layer to the output of the transformer to assign each keyword to categories such as “quality attribute”, “origin”, “material”, or “emotion-related phrase”. The server stores the phrase information in a structured format that preserves both lexical content and semantic labels, thereby enabling downstream enforcement of keyword coverage.

The server executes an emotion estimation program implemented using a multimodal neural network. The server prepares three types of feature vectors: facial feature vectors, voice feature vectors, and input-operation feature vectors. The server derives facial feature vectors by applying a face detection and expression recognition network to the facial image data. The server derives voice feature vectors by computing short-time Fourier transforms of the audio waveform and computing prosodic features such as pitch statistics and energy statistics, followed by a recurrent or transformer-based classifier to recognize emotion classes. The server derives input-operation feature vectors by computing statistical measures such as mean inter-key interval, variance of inter-key interval, and burst length from input timing logs. The server concatenates these three feature vectors and inputs the concatenated vector into a fusion network implemented as a multilayer perceptron. The server trains this network on supervised data containing labels such as “strong positive”, “neutral”, and “negative” using a loss function such as cross-entropy, and updates weights using gradient descent. At runtime, the server outputs emotion information including an emotion label, a confidence score, and continuous valence and arousal values. This emotion information is stored as structured data to be used in the prompt construction.

The server constructs a description request sentence by programmatically combining the attribute information, the phrase information, and the emotion information. The server defines a template for the description request sentence including placeholder slots for product type, visual attributes, user keywords, and the emotional state. The server fills the placeholders with strings derived from attribute labels, normalized keywords, and emotion labels. For example, the server may generate the following description request sentence:
“Product image description: a medium-sized red leather handbag with an elegant design and a visible brand logo. Seller keywords: luxury, Italian-made, genuine leather. Detected seller emotion: strong positive enthusiasm.”

The server then constructs a prompt sentence for a generative AI model by appending an explicit task instruction and constraints to the description request sentence. The server uses a predetermined control phrase indicating role, style, and length limitations. For example, the server may generate a prompt sentence as follows:
“Product image description: a medium-sized red leather handbag with an elegant design and a visible brand logo.

Seller keywords: luxury, Italian-made, genuine leather.

Detected seller emotion: strong positive enthusiasm.

Task: As a copywriting assistant for an online marketplace, use these details to write a persuasive yet factual product description in English. Highlight the luxurious feel, Italian craftsmanship, and quality leather. Keep the description between 80 and 150 words and make it easy to understand for a general audience.”

The server executes a generative AI model implemented as a large-scale transformer language model. The server stores model parameters consisting of embeddings, multi-head attention weights, feedforward network weights, and layer normalization parameters. The server receives the prompt sentence as an input sequence of tokens, converts each token to an embedding vector, and processes the sequence through multiple stacked transformer blocks.

The server generates output tokens one by one, each time computing a probability distribution over a vocabulary using a softmax function and sampling or selecting a token according to a configured decoding strategy. The server uses generation parameters such as a temperature parameter to control randomness, a maximum token count to control length, and a top-p threshold to limit unlikely tokens. The generative AI model produces candidate information, which is a text sequence representing a product description. The server may treat the output text directly as a product description sentence or apply a rule-based parser to extract a product description template, for example by recognizing sentence boundaries and common positional patterns such as “headline sentence”, “feature sentence”, and “usage sentence”.

The server generates a draft product description by inserting or reflecting expressions corresponding to the phrase information and the emotion information into the obtained product description template or product description sentence. The server checks whether each keyword from the phrase information appears in the generated candidate text by performing string comparison or approximate matching using word embeddings. When a keyword is missing, the server inserts an additional clause or phrase into an appropriate position. For example, if “Italian-made” is not included, the server may insert a subordinate clause such as “crafted in Italy” after an existing phrase describing the product's manufacturing. The server modifies the text so that the emotion information is reflected in tone; for a strong positive emotion, the server may preserve or slightly amplify positive adjectives, while for a neutral emotion, the server may reduce overly emotional expressions by replacing them with more factual terms using a small synonym dictionary and a style-control model.

The server stores the draft product description in a dedicated data structure that includes the raw text, a list of covered keywords, a measured length, and a style score. The server computes the length as the number of tokens or words. The server estimates the writing style by applying a classifier model trained to distinguish between styles such as “concise”, “verbose”, “formal”, and “informal”. The server compares the measured length and style classification with predetermined criteria stored in configuration data for the target platform. When the draft product description does not satisfy the criteria, the server generates an additional prompt sentence containing instructions for summarization or style conversion. For example, when the description is too long, the server may generate an additional prompt sentence such as:
“Rewrite the following product description in no more than 100 words, preserving all key product features and keywords: [current draft product description].”

When the description style is inconsistent with required guidelines, the server may generate an additional prompt sentence such as:
“Rewrite the following product description in a neutral and professional tone suitable for an online marketplace, avoiding overly emotional language: [current draft product description].”

The server inputs the additional prompt sentence to the generative AI model using the same transformer architecture and decodes the resulting text. The server then replaces or updates the draft product description with the regenerated text and updates the keyword coverage and style metadata. By incorporating this feedback-driven regeneration controlled by explicit criteria and secondary prompt sentences, the server achieves reduction of redundant trial-and-error interactions between a user and the generative AI model, thereby improving throughput and reducing network traffic.

The server transmits the finalized draft product description to the terminal. The terminal receives the draft product description and renders it on a display device in an editable field.

The terminal allows the user to read, modify, and confirm the description. The terminal may highlight inserted keywords, display an indicator that the description has been generated based on a generative AI model and a prompt sentence, and optionally present the detected emotion state so that the user can understand why certain expressions appear. The terminal transmits a confirmed product description and any additional listing parameters back to the server, and the server may then format the description according to a data schema required by a commerce platform and send it through an application programming interface.

In another embodiment, the server uses a different architecture for the generative AI model, such as a sequence-to-sequence recurrent neural network with attention instead of a transformer model. In this embodiment, the server encodes the prompt sentence into a context vector and decodes the product description sentence token by token. The training of such a model uses a loss function such as cross-entropy between predicted and target tokens, and the server applies optimization techniques such as stochastic gradient descent with momentum during an offline training phase. The server may additionally apply data augmentation to product description corpora, such as paraphrasing sentences or randomly deleting noncritical adjectives, to improve the robustness of the model. Even with this alternative architecture, the server still constructs prompt sentences that include attribute information, phrase information, and emotion information, and still enforces keyword coverage and style constraints as described.

In another embodiment, the terminal executes some of the preprocessing and feature extraction functions locally, thereby reducing communication load and server-side processing requirements. For example, the terminal may execute a lightweight image recognition model to produce preliminary attribute information and transmit only compressed attribute vectors instead of full-resolution images. The terminal may also compute basic emotion features from the microphone and input device, such as average speaking volume and typing speed, and send these features to the server in place of raw audio and low-level timing logs. This configuration reduces bandwidth usage and latency, which is advantageous in wireless networks with limited capacity.

The described configurations produce technical effects at multiple levels. At the data processing level, the fusion of attribute information, phrase information, and emotion information into a single structured prompt sentence improves the alignment between the conditioning information and the generative AI model's internal decision process. This alignment reduces the number of generative iterations required to achieve an acceptable description, and thus reduces computational load. At the system level, the automated enforcement of keyword coverage and style criteria prevents the need for repeated manual corrections by the user and avoids redundant transfers and model invocations. The emotion-aware construction of the prompt sentence results in more predictable and controllable text outputs compared to ad-hoc prompt formulations, which improves the reliability of the system when deployed at scale.

The server improves computer technology itself by introducing a non-conventional dataflow and control strategy for the generative AI model. Rather than simply feeding raw text or attributes into a generic model, the server performs explicit feature extraction, structured prompt assembly, and automatic post-generation correction under machine-interpretable rules. This controlled interaction with the generative model increases computational efficiency and output consistency, providing a technical solution beyond mere automation of human copywriting. The introduced neural architectures, training processes, and data structures are specifically selected to support this workflow, and the described feedback loop between the server and the generative AI model is implemented in program logic that optimizes hardware resource usage, including processor cycles and network bandwidth.

In addition, multiple variations may be adopted within the scope of the claims. The server may use different combinations of libraries for image processing and natural language processing, different numbers of layers and attention heads for the transformer, or different strategies for decoding generated sequences, such as beam search with a specified beam width. The terminal may be implemented on various types of devices that include imaging sensors and processing units, including handheld devices and larger computing devices. The emotion estimation program may omit some modalities when not available and rely solely on the remaining modalities while still generating usable emotion information. In all such embodiments, the core configuration remains that the server constructs a prompt sentence by fusing attribute information, phrase information, and emotion information, and that the generative AI model generates candidate description text which is programmatically verified and corrected according to explicit criteria before being presented as a draft product description to the user.

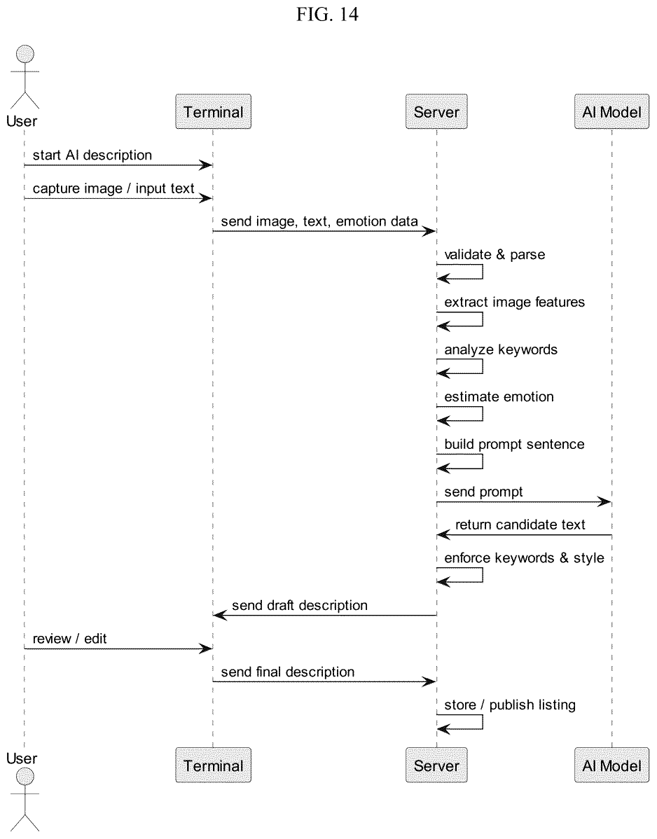

The following describes the processing flow using FIG. 14.

### Step 1:

User operates the terminal application to start description generation.

User activates a listing creation function on the terminal and selects that an AI-based description should be generated.

Input: User actions on the terminal UI (button taps, menu selections).

Output: A terminal screen that displays controls for image capture, text input, and optional emotion-capture settings.

Terminal renders a form with an image capture button, a text field for keywords, and a toggle for emotion analysis. The terminal allocates UI components in memory and prepares to record subsequent sensor and text inputs.

### Step 2:

User captures a product image and confirms it on the terminal.

User points the camera of the terminal at a product and presses a capture button.

Input: Light reflected from the product, received by the terminal camera sensor.

Output: Digital image data representing the product (raw or compressed), stored in terminal memory.

Terminal converts analog sensor signals into digital pixel values, encodes them in a standard format (for example, JPEG), optionally resizes the image, and stores the image file path in a data structure for the current listing.

### Step 3:

User enters product-related text on the terminal.

User types one or more phrases such as “luxury, Italian-made, genuine leather” into a text field.

Input: Key presses or touch inputs, captured by the terminal input device.

Output: Character data (string) representing user keywords stored in terminal memory.

Terminal records each keystroke or text event, converts input into characters using a character encoding, concatenates the characters into a string, and associates the string with the current listing record.

### Step 4:

Terminal optionally collects emotion-related signals.

User may allow access to a front camera and microphone, and continues interacting with the terminal during input.

Input: Facial images captured by the front camera, voice audio captured by the microphone, and event timestamps for user input operations.

Output: Raw facial image frames or short video, raw audio waveform segments, and a list of input timestamps stored in terminal memory.

Terminal periodically samples camera frames while the user faces the terminal, records audio within a given time window if a voice note feature is enabled, and logs the exact times of each keystroke or touch event for later analysis.

### Step 5:

Terminal constructs and transmits a request to the server.

Terminal prepares an aggregated payload containing all collected data and sends it via a communication interface.

Input: Product image data, character data, optional facial image and audio data, and input timestamp data stored on the terminal.

Output: A network request containing encoded data transmitted over a network to the server.

Terminal compresses the image if necessary, encodes audio as a compressed stream, serializes character data into a text field, packages timestamps into a compact array, and constructs a request body that includes these elements. Terminal then opens a secure connection and transmits the payload to a specified server endpoint.

### Step 6:

Server receives and validates the request.

Server accepts an incoming network connection from the terminal and reads the transmitted data.

Input: A network message containing image data, character data, and optional emotion-related data.

Output: Parsed and validated data objects stored in server memory or rejected with an error status.

Server decodes the message body, inspects headers to verify authentication, checks file types and sizes for the image and audio, and ensures the character data length is within defined limits. If validation succeeds, server creates internal objects representing the product image, keyword string, and any emotion-related data.

### Step 7:

Server performs image feature extraction.

Server executes an image processing program to determine attributes of the product from the image.

Input: Decoded product image data stored in server memory.

Output: Attribute information such as predicted product category, color, shape, material, and style.

Server converts the image into a normalized tensor, inputs the tensor into a convolutional neural network, performs convolutions and pooling to create feature maps, and passes the final feature vector through classifier layers. Server then maps classifier outputs to human-interpretable labels (for example, “handbag”, “red”, “leather”, “elegant”) and stores these labels in an attribute structure.

### Step 8:

Server performs keyword and phrase analysis.

Server analyzes the text provided by the user to extract normalized phrases and semantic tags.

Input: Character data representing user-entered keywords.

Output: Phrase information including a list of normalized keyword strings and associated semantic categories.

Server tokenizes the string into separate tokens, applies lowercasing and normalization, maps tokens to vector representations using an embedding matrix, and processes them with a natural language encoder. Server then applies a classifier layer to each token or phrase to determine categories such as “quality”, “origin”, or “material”, and compiles the results into a phrase information object.

### Step 9:

Server estimates the user's emotion state.

Server uses a multimodal emotion estimation program to infer a user emotion from facial images, audio signals, and input-operation patterns.

Input: Facial image data or video frames, audio waveforms, and input timestamp logs received from the terminal (if available).

Output: Emotion information including an emotion label, a confidence value, and continuous scalar scores.

Server extracts visual features from facial images using a neural network trained for expression recognition, extracts acoustic features from audio using short-time spectral analysis and a speech emotion classifier, and computes statistical features from timestamp logs such as average inter-key interval. Server concatenates these features into a single vector, feeds the vector into a fusion network, and computes softmax probabilities over defined emotion classes. Server selects the class with the highest probability as the emotion label and stores the label and associated scores as emotion information.

### Step 10:

Server constructs a description request sentence.

Server generates a natural language sentence summarizing product attributes, user phrases, and the inferred emotion.

Input: Attribute information, phrase information, and emotion information stored in server memory.

Output: A description request sentence expressed as a text string.

Server retrieves attribute labels, formats them into a descriptive clause, retrieves normalized keywords and formats them as a list, and converts the emotion label into a natural language phrase. Server concatenates these components into one or multiple sentences such as:
“Product image description: a medium-sized red leather handbag with an elegant design and a visible brand logo. Seller keywords: luxury, Italian-made, genuine leather. Detected seller emotion: strong positive enthusiasm.”

### Step 11:

Server constructs a prompt sentence for the generative AI model.

Server appends explicit instructions and constraints to the description request sentence to form the final prompt.

Input: The description request sentence generated in the previous step and predefined control instructions stored in configuration data.

Output: A prompt sentence text string suitable for input to a generative AI model.

Server combines the description request sentence with task and constraint instructions, for example:
“Product image description: a medium-sized red leather handbag with an elegant design and a visible brand logo.

Seller keywords: luxury, Italian-made, genuine leather.

Detected seller emotion: strong positive enthusiasm.

Task: As a copywriting assistant for an online marketplace, use these details to write a persuasive yet factual product description in English. Highlight the luxurious feel, Italian craftsmanship, and quality leather. Keep the description between 80 and 150 words and make it easy to understand for a general audience.”

Server stores this resulting text as the prompt sentence.

### Step 12:

Server generates a candidate product description with the generative AI model.

Server calls a generative AI model and obtains candidate text for the product description.

Input: The prompt sentence and model configuration parameters such as maximum token count and temperature.

Output: Candidate text for a product description, represented as a sequence of tokens or a text string.

Server tokenizes the prompt sentence, converts tokens to embeddings, and passes them through a multi-layer transformer network. At each generation step, server computes a probability distribution over the vocabulary and selects the next token based on a configured decoding algorithm. Server repeats this procedure until a stopping condition is met, then decodes the token sequence into a text string representing the candidate product description.

### Step 13:

Server creates a draft product description and enforces keyword coverage.

Server combines the candidate description with phrase information and emotion information to form a draft and verifies inclusion of user phrases.

Input: Candidate description text, phrase information, and emotion information.

Output: A draft product description text that contains all required phrases and reflects the emotion state.

Server scans the candidate description to check whether each normalized keyword appears at least once. For any keyword not found, server generates a short phrase that includes the missing keyword and inserts it into a semantically appropriate position in the text, for example after a sentence describing product quality or origin. Server may also adjust specific adjectives or adverbs to match the detected emotion state, replacing overly neutral words with more positive ones when a strong positive emotion is detected.

### Step 14:

Server validates length and style and optionally regenerates the description.

Server measures the draft description against predefined criteria and, if necessary, refines it through an additional interaction with the generative AI model.

Input: Draft product description text, style classification model, and predetermined criteria for length and style.

Output: A corrected draft product description text that satisfies length and style constraints.

Server counts the number of tokens or words in the draft, inputs the draft into a style classifier to obtain a style label, and compares these results with required thresholds. If the draft is too long or the style is inappropriate, server builds an additional prompt sentence instructing the generative AI model to summarize or restyle the draft, inputs this secondary prompt to the generative AI model, and obtains a revised description. Server then updates the draft description with the revised text and rechecks keyword inclusion, adding any missing phrases as in the previous step.

### Step 15:

Server sends the finalized draft description to the terminal.

Server prepares a response message containing the draft description and transmits it to the terminal.

Input: Finalized draft product description text and associated metadata stored on the server.

Output: A network response message delivered to the terminal that includes the draft description text.

Server places the text into a response structure, sets a status code indicating success, serializes the structure, and sends it to the terminal over the established communication channel.

### Step 16:

Terminal displays the draft description and accepts user edits.

Terminal receives the response from the server and presents the draft description to the user for review.

Input: Network response containing the draft product description.

Output: Edited or confirmed description text generated by the user on the terminal.

Terminal parses the response, extracts the draft description string, and inserts it into an editable text component on the display. User reads the description, optionally modifies phrases or adds missing details using the input device, and then confirms the final version. Terminal stores the user-edited text and associates it with the listing.

### Step 17:

Terminal submits the final product description and listing data to the server.

Terminal packages the confirmed description together with other listing information and sends it to the server.

Input: Confirmed description text, product image reference, and other listing parameters stored on the terminal.

Output: A listing creation request transmitted to the server.

Terminal compiles a payload containing the final description, product attributes known locally (such as category and price), and identifiers for uploaded images, and sends this payload to a dedicated listing endpoint on the server.

### Step 18:

Server formats and stores the listing information for publication.

Server receives the final listing data and prepares it for use by a commerce platform or auction platform.

Input: Final product description text and associated listing parameters received from the terminal.

Output: A stored listing record and, when applicable, a formatted output suitable for a target platform.

Server validates required fields, stores the listing record in a database, and converts the description into a platform-specific format if necessary. Server may then forward the listing to another system through an interface or store it for later retrieval, completing the processing flow based on the generative AI model and prompt sentence.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

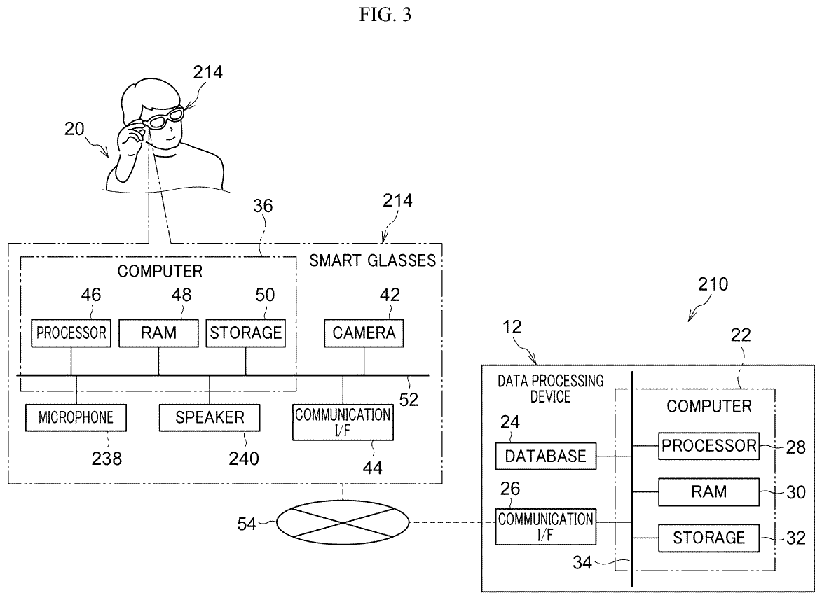

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

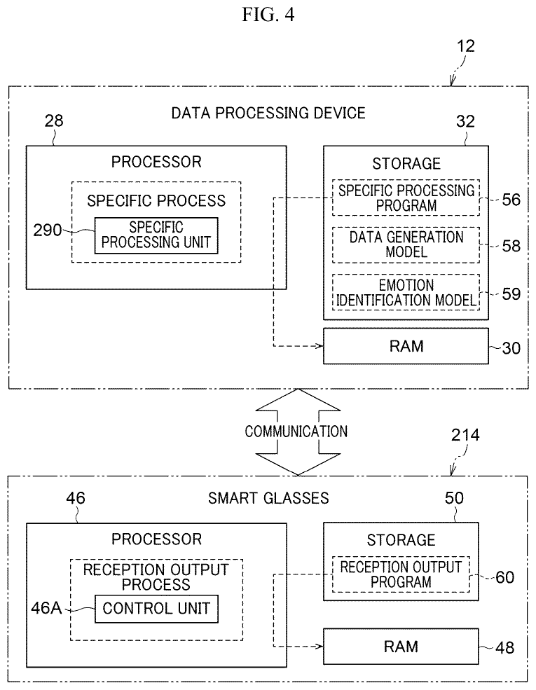

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

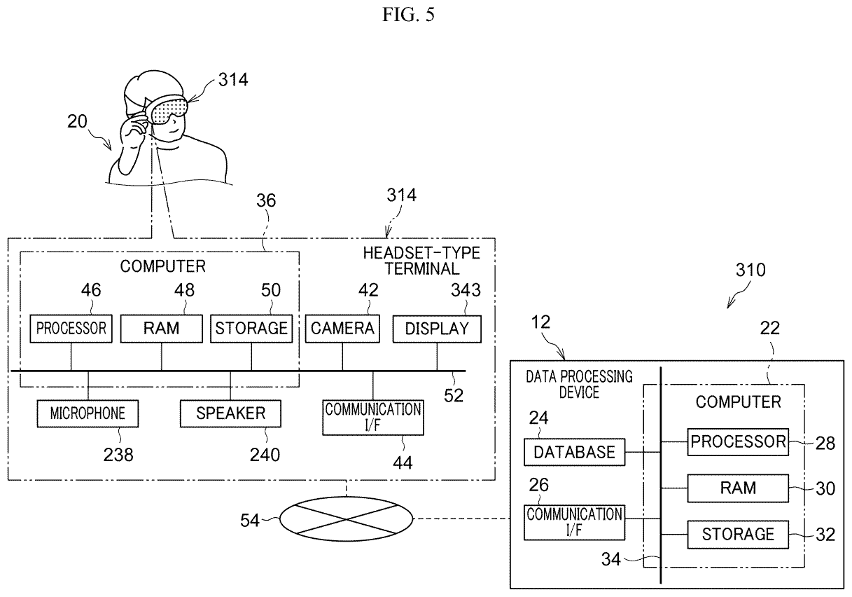

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

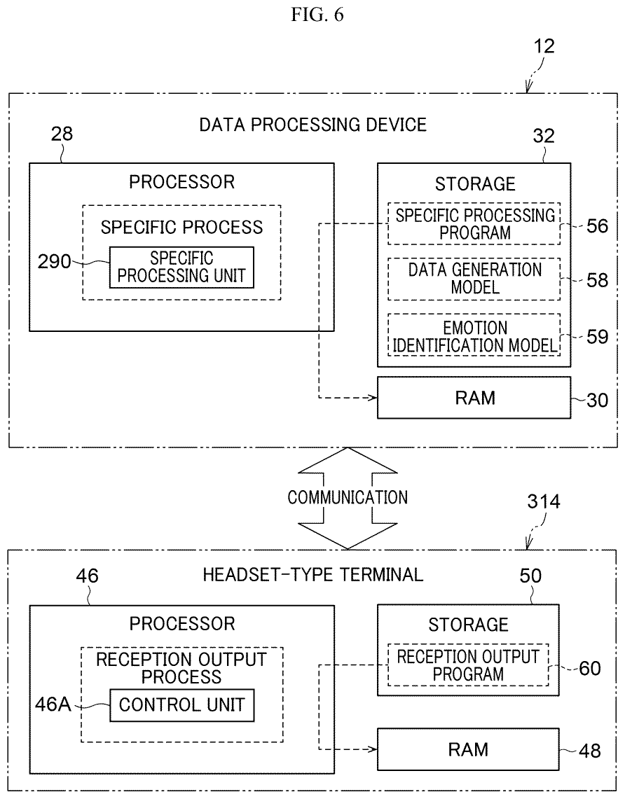

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

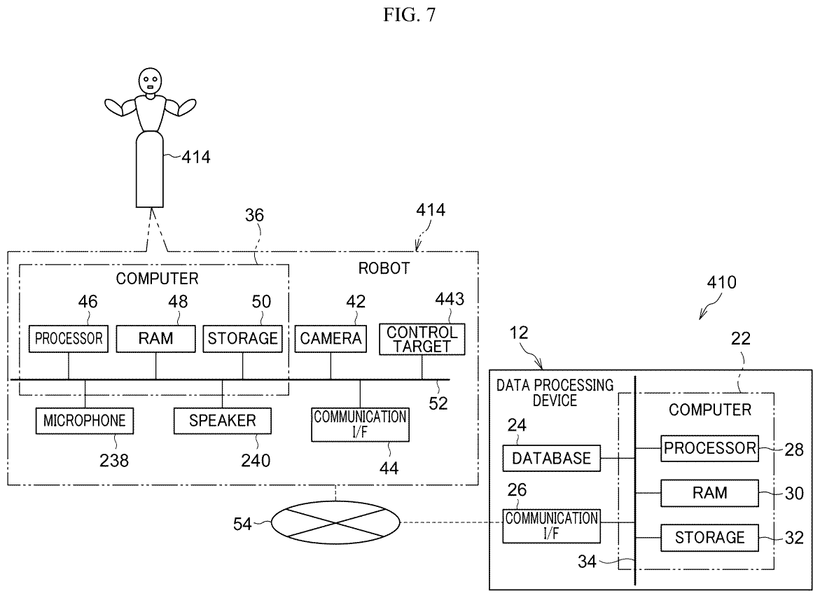

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

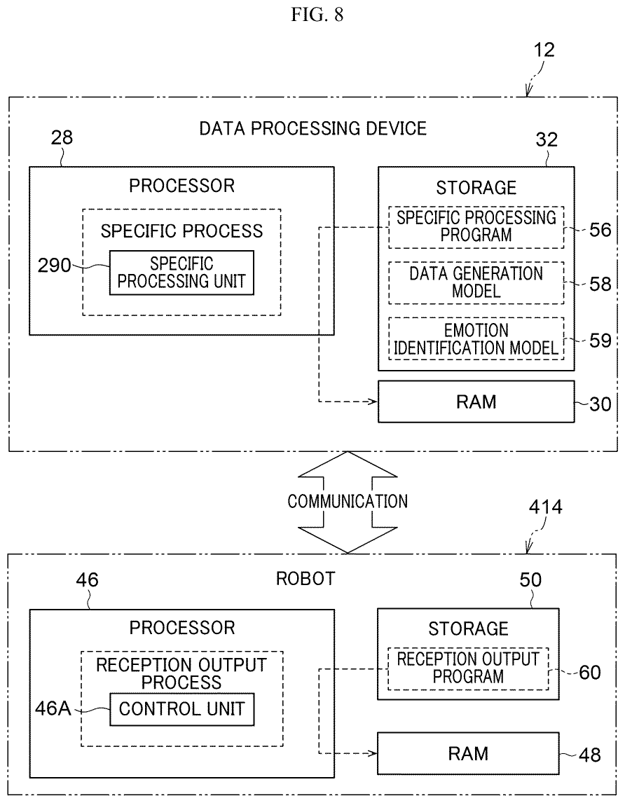

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

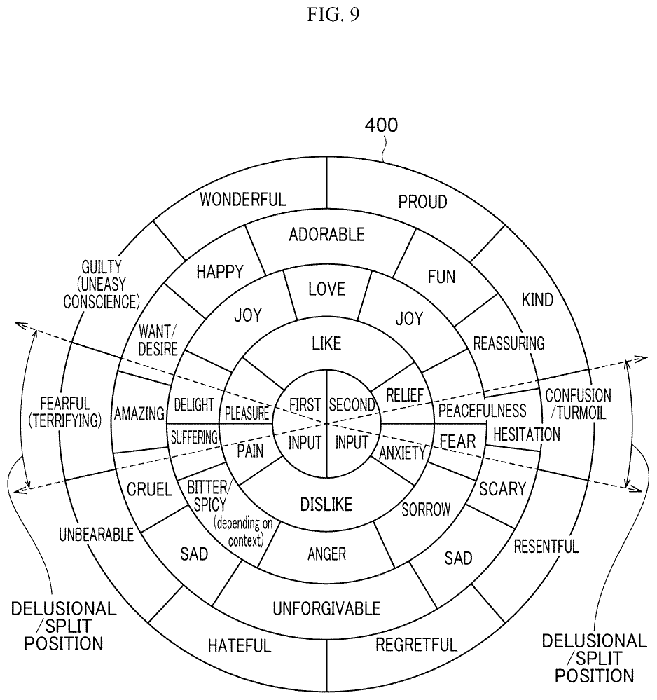

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

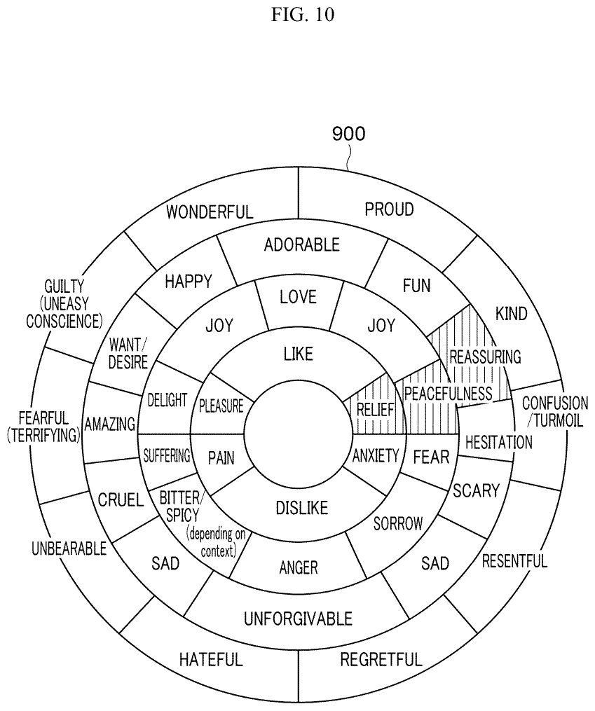

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide a user interface that receives, from a user terminal, image information representing a product and optional character information input by a user,
acquire the image information and apply an image processing algorithm and a machine learning algorithm to pixel information included in the image information to extract feature information including category information of the product, color attribute information, shape attribute information, and mark attribute information,
convert the feature information into structured data and, based on the structured data, execute a query process on an information storage device that stores a plurality of description template pieces of information, and select description template information corresponding to at least the category information of the product and style information,
apply a natural language processing algorithm to the optional character information to analyze word information, phrase information, and semantic role information, classify the optional character information into at least feature information of the product, use-scene information, and advantage information, and associate a classification result with section information or placeholder information within the description template information, replace attribute placeholders within the description template information with values based on the feature information and, based on the association, insert the optional character information into predetermined positions within the description template information to generate description text information serving as a draft of a product description,
generate, based on description condition information including the feature information and the optional character information, a prompt sentence for instructing a generative artificial intelligence model to generate or improve product description text, input the prompt sentence into the generative artificial intelligence model, and generate, from output of the generative artificial intelligence model, a draft of a product description in which the description text information is corrected or extended, and
provide the generated draft of the product description to the user terminal via the user interface.

### (Supplementary 2)

The system according to supplementary 1,
wherein the processor is configured to
control the user interface to display the generated draft of the product description as an editable character-editing region and to receive additional input or correction input from the user.

### (Supplementary 3)

The system according to supplementary 1,
wherein the processor is configured to
convert, after editing by the user, the draft of the product description into a data structure for listing processing in an electronic transaction platform, and output listing data including the product description, price information, delivery information, and other product-related information.

### Application Example 1

### (Supplementary 1)

A system comprising a processor,
wherein the processor is configured to
provide, to a user terminal via a communication network, an interface for acquiring a product image and optional text data input by a user,
preprocess the product image by using an image recognition algorithm based on machine learning to normalize pixel data into a predetermined input format, calculate a feature quantity corresponding to the product image, and generate structured data including attribute information of a product based on the feature quantity,
generate a prompt sentence including control information for searching and selecting, based on the attribute information, a product description template associated with a product classification and a style from among a plurality of product description templates stored in a storage device,
input the prompt sentence into a generative AI model that performs natural language processing, and cause the generative AI model to generate, in natural language, a product description proposal including information on selection of the product description template and insertion positions of the optional text data,
generate a draft product description by combining the product description template, the optional text data, and the product description proposal obtained from the generative AI model, and perform a formatting process on the draft product description based on a predetermined length constraint, a keyword inclusion condition, and a writing style condition, and
transmit the generated draft product description and the attribute information of the product as data in an editable display format to the user terminal, and provide the draft product description and the attribute information through a user interface of the user terminal.

### (Supplementary 2)

The system according to supplementary 1,
wherein the processor is configured to
acquire, from the user terminal, edit content made by the user to the generated draft product description, and reuse updated text data including the edit content as an additional prompt sentence to the generative AI model, thereby executing control to regenerate or improve the draft product description.

### (Supplementary 3)

The system according to supplementary 1,
wherein the processor is configured to
convert a finalized product description, which has been confirmed after editing by the user, and the attribute information of the product into a listing data format for an electronic commerce platform, and output listing data registerable in a listing management function of the electronic commerce platform.

### Example 2

### (Supplementary 1)

A system comprising a processor,
wherein the processor is configured to
receive, via a display device and an input device connected to an information processing apparatus, image data obtained by imaging a transaction target article and arbitrary character information related to the transaction target article from a user,
preprocess the image data by using an image processing program and a machine learning program executed on a general-purpose information processing apparatus, and convert the image data into numerical sequence data suitable for inference processing by the machine learning program,
execute, on the numerical sequence data, a trained inference model including at least one of a classification processing model, a feature extraction model, and an object detection model, and extract feature information including attribute information, appearance information, and identification information of the transaction target article,
apply a template selection rule to the feature information, the template selection rule being configured to select, from among a plurality of description template data stored in a storage device, description template data corresponding to a type or a category of the transaction target article, and thereby specify the description template data,
construct, as a prompt sentence described in a natural language, context information including the feature information and the arbitrary character information, designation information related to the description template data, and instruction information related to a style, a length, and an expression range of a description sentence,
input the prompt sentence to a generative AI model including a generative language model that executes natural language generation processing, and obtain, from the generative AI model, a product description candidate sentence that conforms to a format of the description template data,
execute post-processing on the product description candidate sentence, the post-processing including at least one of detection of prohibited expressions, length adjustment, format adjustment, and conversion into structured data, and
store the post-processed product description candidate sentence in association with the arbitrary character information, and display the post-processed product description candidate sentence on the display device in a state editable via a user interface.

### (Supplementary 2)

The system according to supplementary 1,
wherein the processor is configured to
acquire edit content applied to the product description candidate sentence by the user via the input device, generate a finalized product description sentence reflecting the edit content, convert the finalized product description sentence into a listing data format for electronic commerce, and store the listing data format in the storage device.

### (Supplementary 3)

The system according to supplementary 1,
wherein the processor is configured to
generate a listing data record including the finalized product description sentence, the image data, and transaction condition information related to the transaction target article, and convert the listing data record into a transmission data format transmittable to an electronic commerce service via a communication network.

### Application Example 2

### (Supplementary 1)

A system comprising a processor,
wherein the processor is configured to
receive, from a user terminal, image information representing a product and character information representing user-input text related to the product,
analyze the image information by inputting the image information to an image processing program and extracting attribute information of the product from the image information, analyze the character information by inputting the character information to a natural language processing program and extracting phrase information related to the product from the character information,
estimate an emotional state of a user by inputting at least one of facial information, voice information, and input operation information acquired from the user terminal into an emotion estimation program, and generate emotion information based on the estimated emotional state,
generate, on the basis of the attribute information, the phrase information, and the emotion information, a description request sentence including contents of the product image, phrases input by the user, and the emotional state of the user, and generate a prompt sentence for input to a generative information generation model by using the description request sentence as the prompt sentence for the generative information generation model,
input the prompt sentence to the generative information generation model, cause the generative information generation model to generate candidate information for a product description sentence, and obtain a product description template or a product description sentence from the candidate information,
generate a draft product description by inserting or reflecting, in the obtained product description template or the obtained product description sentence, expressions corresponding to the phrase information and the emotion information, and
transmit the generated draft product description to the user terminal and present the draft product description through a user interface of the user terminal.

### (Supplementary 2)

The system according to supplementary 1,
wherein the processor is configured to determine whether each phrase included in the phrase information is contained at least once in the draft product description, and, when a phrase that is not contained in the draft product description exists, automatically add wording including the phrase to the draft product description to correct the draft product description.

### (Supplementary 3)

The system according to supplementary 1,
wherein the processor is configured to compare a length and a writing style of the draft product description with predetermined criteria, and, when the length or the writing style deviates from the predetermined criteria, generate an additional prompt sentence instructing the generative information generation model to perform summarization or style conversion of the draft product description, input the additional prompt sentence to the generative information generation model, and regenerate or modify the draft product description based on an output result from the generative information generation model.

What is claimed is:

1. A system comprising:
circuitry configured to
receive, via a communication interface coupled to a packet-switched network, image data and supplemental text data from a terminal device,
apply a trained inference model to a multidimensional tensor derived from the image data to extract feature information comprising classification information and attribute information,
construct, based on the extracted feature information, a prompt sentence for a generative neural network model, the prompt sentence instructing the generative neural network model to select template data from a plurality of template data records stored in a storage device,
input the prompt sentence to the generative neural network model to cause the generative neural network model to output selection information identifying selected template data,
generate structured output data by inserting the supplemental text data into the selected template data, and
transmit the structured output data to the terminal device for display via a graphical user interface.

2. The system according to claim 1, wherein the circuitry is further configured to preprocess the image data by resizing pixel values to a predetermined resolution and normalizing the pixel values to generate the multidimensional tensor.

3. The system according to claim 2, wherein the trained inference model comprises a convolutional neural network having a plurality of convolutional layers and a plurality of pooling layers, and wherein the circuitry is configured to execute a forward propagation through the convolutional neural network to compute probability distributions over a set of predefined classification labels.

4. The system according to claim 3, wherein the classification information comprises category information of a product depicted in the image data, and the attribute information comprises at least one of color attribute information, shape attribute information, and mark attribute information extracted from the image data.

5. The system according to claim 4, wherein the circuitry is further configured to derive style information by applying a rule-based mapping to a combination of the category information and the attribute information, and to include the style information in the prompt sentence.

6. The system according to claim 1, wherein the circuitry is further configured to apply a natural language processing algorithm to the supplemental text data to extract word-level information, phrase-level information, and semantic role information, and to classify each phrase into at least one of feature information, use-scene information, and advantage information.

7. The system according to claim 6, wherein the circuitry is further configured to map each classified phrase to section information or placeholder information within the selected template data based on a predetermined mapping configuration.

8. The system according to claim 7, wherein the circuitry is further configured to replace attribute placeholders within the selected template data with values derived from the feature information prior to inserting the supplemental text data.

9. The system according to claim 1, wherein the prompt sentence further comprises instruction information specifying at least one of a style condition, a length constraint, and an expression range condition for output of the generative neural network model.

10. The system according to claim 9, wherein the circuitry is further configured to receive, from the generative neural network model, candidate text data, and to merge the candidate text data with the structured output data by applying attribute coverage rules that require presence of the classification information and the attribute information in the merged output.

11. The system according to claim 10, wherein the circuitry is further configured to execute post-processing on the merged output, the post-processing comprising at least one of detection of prohibited expressions, length adjustment, and format adjustment.

12. The system according to claim 1, wherein the circuitry is further configured to provide the graphical user interface as an editable display region on the terminal device, and to receive edit content applied by a user to the structured output data.

13. The system according to claim 12, wherein the circuitry is further configured to construct an additional prompt sentence incorporating the edit content and to input the additional prompt sentence to the generative neural network model to regenerate or refine the structured output data.

14. The system according to claim 13, wherein the circuitry is further configured to compare a length and a writing style of the regenerated structured output data with predetermined criteria, and when the length or the writing style deviates from the predetermined criteria, to generate a further prompt sentence instructing the generative neural network model to perform summarization or style conversion.

15. The system according to claim 1, wherein the circuitry is further configured to estimate an emotional state of a user by inputting at least one of facial information, voice information, and input operation information acquired from the terminal device into an emotion estimation model, and to incorporate emotion information based on the estimated emotional state into the prompt sentence.

16. The system according to claim 15, wherein the emotion estimation model comprises a multimodal neural network configured to receive a concatenated feature vector derived from at least two of a facial expression recognition network, a speech emotion classifier, and an input timing statistical module, and to output an emotion label and a confidence score.

17. The system according to claim 1, wherein the structured output data comprises a draft product description, and the circuitry is further configured to convert the draft product description into a listing data format for an electronic commerce platform, the listing data format comprising the draft product description, price information, and delivery information.

18. A system comprising:
circuitry configured to
receive, via a communication interface coupled to a packet-switched network, image data and supplemental text data from a terminal device,
preprocess the image data by normalizing pixel values and resizing the image data to a predetermined resolution to generate a multidimensional tensor,
apply a trained convolutional neural network model to the multidimensional tensor to extract feature information comprising classification information, color attribute information, shape attribute information, and mark attribute information,
apply a natural language processing algorithm to the supplemental text data to extract phrase-level information and to classify each phrase into at least one of feature information, use-scene information, and advantage information,
construct, based on the extracted feature information and the classified phrase-level information, a prompt sentence for a generative transformer-based language model, the prompt sentence comprising context information encoding the feature information, designation information identifying template data, and instruction information specifying at least one of a style condition and a length constraint,
input the prompt sentence to the generative transformer-based language model to cause the generative transformer-based language model to generate candidate text data conforming to a format of the template data,
generate structured output data by combining the template data, the classified phrase-level information, and the candidate text data, and
transmit the structured output data to the terminal device for display via a graphical user interface in an editable state.

19. The system according to claim 18, wherein the circuitry is further configured to receive edit content from the terminal device, to construct an additional prompt sentence incorporating the edit content, and to input the additional prompt sentence to the generative transformer-based language model to regenerate the structured output data.

20. A method comprising:
receiving, via a communication interface coupled to a packet-switched network, image data and supplemental text data from a terminal device,
applying a trained inference model to a multidimensional tensor derived from the image data to extract feature information comprising classification information and attribute information,
constructing, based on the extracted feature information, a prompt sentence for a generative neural network model, the prompt sentence instructing the generative neural network model to select template data from a plurality of template data records stored in a storage device,
inputting the prompt sentence to the generative neural network model to cause the generative neural network model to output selection information identifying selected template data,
generating structured output data by inserting the supplemental text data into the selected template data, and
transmitting the structured output data to the terminal device for display via a graphical user interface.
